(19) United States
(12) Patent Application Publication
(10) Pub. No.: US 2017/0138331 A1
(43) Pub. Date: May 18, 2017

(54) VARIABLE AREA BLADE TURBINE AND CONDITIONING FLOW DEFLECTORS DEVICE AND METHOD

(71) Applicant: Corporacion Andina De Fomento, Caracas (VE)

(72) Inventors: Concepcion VISIERS DE TORAN, Caracas (VE); Jose Toran, Caracas (VE)

(21) Appl. No.: 15/353,343

(22) Filed: Nov. 16, 2016

Related U.S. Application Data
(60) Provisional application No. 62/255,872, filed on Nov. 16, 2015.

(51) Int. Cl. F03B 3/14; F03B 3/18

(52) U.S. Cl. CPC F03B 3/145; F03B 3/18; F05B 2220/32

(57) ABSTRACT

A mechanism to provide controlled variable area blades for fluid driven tangential turbines is disclosed, where the spindle axis is perpendicular to the fluid flow, applicable in vertical axis hydraulic turbines but extensive to horizontal axis or wind turbines, with the rotor completely immersed on the flow. Each blade varying its area at selected position of the rotor turning, increasing to maximize conversion of the kinetic energy of the fluid onto mechanical rotational power of the shaft, or reducing to minimize drag moving opposed to such current. A comprehensive method is provided to control the variation in area for any specific degree of rotation of the turbine shaft on a rotational blade array, different flow conditioning deflector solutions in order to increase the power generation capability of the turbine, by increasing speed of the incoming flow to the rotor and minimizing drag of the returning blades.

### CROSS REFERENCE TO RELATED APPLICATION

This application claims the benefit of priority of U.S. Provisional Patent Application No. 62/255,872, filed on Nov. 16, 2015, application which is incorporated herein in its entirety for all purposes.

### BACKGROUND OF THE INVENTION

The development and marketing of hydrokinetic renewable energy technologies of low (5 kW) and medium (250 kW) power to provide energy to isolated rural communities near navigable rivers in basins around the world, such as the West Amazon basin and others in Africa and Asia, is a short-term priority due to the high costs of electric energy in isolated communities in these basins. Currently, the governments of these regions are interested in improving the quality of life of communities there, and in reducing the high subsidies that are currently being used to provide energy to these areas. Electric power in these communities is usually provided by small diesel generators that are very costly to operate (diesel must be transported hundreds of kilometers through boats).

Given the geographic, ecologic, and climate characteristics, as well as the difficult access, areas such as the central part of the West Amazon basin have few economically feasible technologic alternatives to bring electricity to their communities. The conventional network extension modality commonly used to provide electricity to rural communities and to connect them to the interconnected system is not feasible in these areas not only because of their distances, but also due to the density of the tropical forest, and how inaccessible and dispersed the communities are.

Another conventional modality currently used to provide electricity to isolated rural communities such as the West Amazon, is bringing electricity through network extensions of the isolated systems under concession. The use of this modality is only feasible in communities that are relatively close to departmental or provincial capitals that have isolated systems under concession. Electricity has already been provided to one part of the West Amazon area through the extension of the network from diesel generation isolated systems, located primarily in the provincial and municipal capitals.

The introduction of new technologies to provide electricity to isolated communities in tropical basins is a way to solve this problem, while at the same time providing support to the technological capacities to strengthen the region's innovative system.

Hydrokinetic energy conversion systems from river currents have been implemented since ancient times. The development of hydrokinetic energy converters for high-flow rivers, but with very low hydraulic or water head, is in its beginning stages. There are very few technologies available on the market, currently only two: a) Garman axial flow-type turbines; and b) Darrieus cross flow vertical axis turbines. The available Garman turbines have a very low capacity (1 to 2 kW), but greater capacity Darrieus-type turbines can be found in the market (5 to 25 kW). Both types of turbines need a minimum speed of 1.5 m/s to work effectively, and this would limit its use in a great number of the rivers considered in the central area of the West Amazon basin, where the average speed of the flow of water is between 0.9 to 1.3 m/s. Both types of turbines would also be exposed to the risk of being hit by floating material (trees, branches, roots, etc.), which is very common in Amazon rivers.

Therefore, there is the need for the development of technological concepts oriented to work effectively (i.e., generate electricity affordably) in rivers with the conditions and characteristics mentioned above. These new technologies should comply with the following parameters: a) the concept should be modular, and should include the full hydrokinetic energy conversion systems or processes, and function independently from other structures; b) the main source of energy is hydrokinetic, considering speeds of river flows ranging between 0.9 to 1.5 m/s; c) the concept should be designed for capacities starting from 1 kW of power and up; d) the concept consider the risks of being impacted with floating material (trees, branches, roots, etc.), which are very common in navigable rivers, especially in basins such as the Amazon Basin and others.

### SUMMARY OF THE INVENTION

The present invention relates to a modular device consisting of a fluid driven turbine for power generation purposes, for example of the type known as tangential flow, where the spindle axis of the turbine is perpendicular to the fluid flow, with a rotating rotor completely or partially immersed on the flow, that may comprise a number of blades from two up to a non-determined number attached to the rotor body, which use a method to vary their area in a controlled manner by means of the proper rotation of the rotor in order to increase the energy transference from the fluid to the rotor when they move on the same direction of the fluid, calling the blades at this stage of the rotation as the “working blades, and decrease the drag force produced when they move opposed to the fluid flow, calling the blades at this stage of the rotation of the rotor as the “returning blades”. The circulation of the fluid as it passes through the turbine may be conditioned by means of deflector bodies, which may also work as structural, anchoring or floating elements. The flow conditioning consists in accelerating and directing the fluid at the turbine inlet in order to increase the energy transference from the fluid to the “working blades”, and diminishing the pressure, vary the speed and even alter the direction of the fluid flow on the “returning blades” in order to reduce their moving resistance. Without the area modification or flow conditioning the tangential turbines with an immersed rotor have an efficiency and net output power generation low, because the power generated by the “working blades” called the “working torque” is used to overcome the resistance of the “returning blades” called the “return torque”. To maximize the output power generation of the turbine it is required to either increase the “working torque”, reduce the “return torque” or both simultaneously.

It is the main objective of the present invention to use the hydrokinetic energy of a fluid flow source in order to transform it into mechanical or electrical power. The present invention best use is mainly directed to be used on vertical axis turbines immersed on low speed water currents like rivers or water channels, but it is not limited to other applications like horizontal axis turbines or other kind of fluid flow like wind on Eolic turbines. The purpose of the present invention is to increase the efficiency and the net output power generation of this kind of turbines in order to make feasible and viable its use in mechanical and electrical power generation matters.

It is another objective of the present invention to allow easy placement of the device on any spot of a water channel, mainly rivers, depending on the characteristics of such channel, especially due to seasonal changes in flow, water level, sediments or any other reason associated to improve device performance, safety, or convenience, without requiring any major civil foundations or construction.

It is another objective of the present invention to allow a flexible set up of the device in order to get the highest power output depending on the flow conditions with minimal user interaction or at least by means of non-technical personnel.

It is also an objective of this invention to operate in a reliable way in remote areas with no human attendance during operation and minimal maintenance intervention.

It is another objective of the present invention to provide a resistant structure and mechanisms to survive for collisions with elements being dragged by the water current.

It is another objective of the present invention to be easily transported long distances by any means, especially when being towed or shipped by any small or medium size river crafts.

It is another objective of this invention to provide power generation modules that can be combined in different arrangements in order to increase power output level obtain power output uniformity, maximize benefit of water source conditions and adaptations to changes on the water source channel.

It is another objective of the present invention to easily increase or reduce modules of power generation according to the energy demand or user requirement. It is also an objective to scale the size of the elements depending on the flow or demand conditions.

It is another objective of the present invention to provide an easy to maintain device considering it may be operating in remote areas far from technical service providers or spare parts suppliers.

In order to accomplish these objectives it is disclosed a modular power generation apparatus wherein each module may be anchored or comprise floating bodies, the deflectors (which may also play the function of floating and/or anchoring bodies), the fixed guiding system, the platforms (which can also play the function of the guiding plate), the blade's rotor assembly (composed by the fixed and movable blades with their follower guidance element and the rotor), the mechanical transmission and the power generation unit. The present invention is disclosed focusing on nine different embodiments, all of them working with the same operating principle of a partially or fully immersed rotating rotor with a non-specified number of blades attached to it radially, with its rotating axis vertically oriented and kept in position respect to the water surface or the soil depending on the type of application, by means of the anchoring and floating bodies, in which the blades have a mechanism to controllably change its area facing the flow (i.e., the effective area of the blades), allowing to set a desired area at different angles along a single rotation of the rotor, in such a manner it allows to take the most of the energy of the flow in the rotation sector where the blade is pushed by the flow, area of the “working blades”, and minimize its resistance when they move opposed to the flow direction. As the force exerted by the fluid to the blade is proportional to the speed (or square of the speed) of the flow, the density of the flow and the projected area of the blade in a perpendicular direction to the flow direction, the larger the effective area of the blade when it moves on the same direction of the flow, produces a higher working torque on the rotor, while the lesser effective area the blade when it moves in opposed direction to the flow, produces a smaller resisting torque on the rotor. The net torque on the rotor will be equal to the sum of the working torques minus the sum of the resistance torques. The net output power is proportional to the net torque times the angular speed of rotation of the rotor.

There are four notorious positions of each blade along a single rotation of the rotor, separated at 90 degrees from each other, being the “thrust point” the position at an angle where the blade produces the highest working torque, where the projected area of the blade perpendicular to the flow direction must be the greatest possible; the “downstream neutral point”, at which the blade is at its downstream position and is aligned with the flow direction, producing a minimal or null torque on the rotor; the “drag point”, which is at 180 degrees from the “thrust point” and it is the angle at which the blade shows its highest projected area perpendicular to the flow while moving in opposed direction to such flow, producing the theoretical highest resistance torque on the rotor; and the “upstream neutral point” at which the blade is at its upstream position and is aligned with the flow direction, producing a minimal or null torque on the rotor. The change in the effective area for each single blade as the rotor spins may occur soft or gradually or in a step to meet the goals of each effective area or the rotation. The region from the “upstream neutral point”, passing through the “thrust point” up to the “downstream neutral point” is called the “working region”, because is the region where the blade is pushed by the fluid flow, while the region from the “downstream neutral point”, passing through the “drag point” up to the “upstream neutral point” is called the “return region”, because is the region where the blade needs to move against the fluid flow in order to position back to the “working region”.

The method used to produce a variation on at least one of the blade's effective area consists on restraining at least one element of each blade called “the follower” over a fixed static guide not belonging to the rotor called “the fixed guide”, which has a geometrical profile around the axis of the rotor. The profile is preferably closed, it means the start point and the end point after a complete turn of the rotor are the same, but is not limited to opened profiles, and with the contact between the “Follower” and “the fixed Guide” not restricted to a flat plane which means that the guide may define a deformation path that defines a radial movement of the follower or an axial movement of the follower with respect to the rotation axis of the rotor. The deformation path can be either symmetrical or not, may have curved or linear segments or can have a mixture of concave or convex areas. The geometry of the deformation path will depend of the specific performance characteristics desired for the device, being all of the deformation paths (or ‘profile’) described in this document merely examples to illustrate the operating principle of each embodiment. The position of the follower (from one up to a non-specified number) of each blade and its corresponding guide may be at the extremes of the blade or on any non-specified portion of the length of the blade. For the purpose of the present disclosure, are used examples with one or two guides, corresponding to one or two followers for each blade, located on the extremes of the length of the blade, but the present invention is not limited to these guidance configurations. Each blade has one or more portions or parts of its body with capability to relatively move with respect to the others parts of the same blade. All of those parts or portions of the blade progressively change their orientation, relative position between them, or even controllably deform along one rotation of the rotor, having enough strength to not unintentionally deform or freely move from the intended position for each angle along the rotor rotation because the effect of the forces with the flow. While the blades move along the “working region”, they produce the working torque on the rotor, which is the one that allow the rotor keep moving. The series of followers are attached to the blade so that the followers are configured to move cooperatively with at least one of the blades (or, equivalently with the rotor), this movement makes the followers in each blade to move restrained to its guide, producing a pull or push force on the movable parts of the blade, making them to controllably deform, e.g., displace, rotate, etc. in order to rearrange themselves in the area configuration intended according to the position and region where the blade is at each particular angle along the rotor rotation. In other words, the follower adapted to perform a deformation action on at least one of the blades wherein the deformation action on the blades is determined by the position of the follower along the deformation path, being such deformation path defined, as explained above, by the guide. For a blade which is passing through the “working region” the movable parts of that blade rearrange in such a manner that the total area of the blade in perpendicular direction to the flow be the highest possible. For a blade which is passing through the “return region”, the movable parts of that blade rearrange because of the forces induced by the follower movement, in such manner that the total area of the blade on the tangential direction of the rotation for each instant of the movement be the least possible. The movable parts of the blade (MPB) can relatively displace by means of mechanical bearings, guides, articulated linkages or any other mechanical known element of different materials in order to result in a precise location of the MPB, with low friction, minimal inertia and weight, durable to wearing, offering resistance for long operation immersed on the working fluid with minimal maintenance intervention, and capable to maintain the stiffness of the blade in order to transmit the maximum energy from the fluid to the rotor rotation.

Additionally to the blade area variation method described previously in order to increase the net output torque of the turbine rotor, the present invention includes the use of flow conditioning elements in order to improve the energy transmission from the flow current to the blades along the “working region”, and minimize the effects of the movement resistance of the blades while they pass along the “return region”. The elements in charge of the flow conditioning are called deflectors, and beside of this function they can also have structural, anchoring or floatability functionalities on the turbine device. The preferred use of the deflectors is working simultaneously with a variable area blade turbine as described on the present embodiments, but they can be used in any other kind of devices requiring flow conditioning, not limited to turbines. The flow conditioning of the deflectors for the particular use of this invention consists on accelerate the flow coming into the “working region”, increasing the kinetic energy of the flow what result in a higher energy transferred to the rotor through the blades, while on the “return region” the deflector blocks the flow current, slowing down the speed of the flow moving opposed to the blade displacement, and even inducing flow currents on the direction of those blades in order to reduce the resisting torque opposing to the working torque of the rotor. Another function of the deflector on the “return region” is to reduce the pressure of the fluid in that region by means of improving the evacuation of the fluid in that region avoiding the stagnation and recirculation effects because of the induced flow counter-currents.

All the different embodiments of the present invention include the use of the blade area variation method but not all of them require the application of the flow conditioning method, meaning the use of deflectors, being possible to have devices with no deflector at all, having a single deflector per rotor either the so called “blocking deflector” or the “acceleration deflector” or using both at the same time for every rotor. The “blocking deflector” covers the side of “return region” of the rotor diminishing the speed of the flow passing through this region, and the “acceleration deflector” or “inlet deflector” act accelerating the flow passing through the “working region” of the rotor, increasing the energy transference to the rotor. Both deflectors can be differentiated parts, each of them with a different geometry, however the preferred application of the deflectors of this invention is using two equal deflectors, non-symmetrical, with a geometry specific for the functions of each region on both sides, in order to take advantage of the modularity and scalability of the solution, related to economics, manufacturing, logistics and maintenance matters.

The proposed methods for the change in area of the blade are presented in the embodiments one to five. The first embodiment of the present invention represents a method of changing the area by using nested or telescopic MBP, in such a manner that each MBP can extend or contract as desired, having each rotor blade at least one fixed blade part preferably attached to the rotor, respect to which the other MBP will displace. The fixed blade part (FBP) could have an area big enough to let the MBP's to hide inside or behind of it in such a manner that this FBP would represent the minimal blade area for the blades moving along the “return region”. When a blade moves on the “working region” all the MBP extend out of their retracted position in order to increase the overall area of the blade. The displacement of each MBP can be produced by the pulling or pushing force of either one or more followers or another contiguous MBP. There is not a determined number of MBP, being the minimal required at least one FBP and one MBP.

The second embodiment of the present invention is a method of area variation consisting in opening and closing windows internally to the blade area. On the “working region” where the area must be maximized, those windows are closed, while on the “return region” where it is desired the minimal blade area, the windows are opened. The opening and closing of the windows for this embodiment is achieved by moving at least one MBP with respect to other MBP or the FBP. This movement may be radial displacements, axial displacements, rotations or combination of them. The movement of the MBP is made by means of the pulling or pushing forces of the follower or followers as they move over the guiding system, being this movements not limited to a flat plane (mainly radial) but being also in axial direction, which is used for the MBP's with axial displacements, which results in a fixed guide element which makes the follower or followers to describe a 3D curve trajectory along a whole turn of the rotor.

The third embodiment of the present invention is a method of area variation consisting in reorienting the MBP mainly by means of a rotation over an axis in such a manner that while the blade passes through the “working region” each MBP is oriented facing its lateral side to the flow, while in the “return region” reorients to face the flow with its thinner nose or tail side, rearranging in a manner that all the MBP's of a single blade are aligned in parallel. For this purpose each MBP must have an airfoil shape and function, with a cross section showing a nose and tail narrower than the lateral sides in order to change the force exerted by the current on its surface depending on the orientation of the attack angle, which comes from the reorientation of the MBP mentioned. The number of MBP can be from one up to a not determined number, and the followers can act directly on the MBP or over another element which will be in charge of transmitting the movement to the MBP depending on the profile of the guide. The rotation axis of the MBP can be parallel, perpendicular or oblique to the rotation axis of the rotor, being the preferred option the parallel axis in order to make easy the transmission of the movement of the followers onto the reorientation of the MBP's.

The fourth embodiment of the present invention refers to a method of varying the area of the blade by means of folding or bending of a number of MBP or the whole blade itself. When the blade is passing through the “working region” it is completely extended in order to face the flow with the highest area possible, while when it passes through the “return region”, the blade pleats by means of an articulated guidance system which is moved by the action of the follower which displaces over the guide. The articulated guidance system (AGS) controls the way how the blade is folded whether it is a single foldable sheet blade of a flexible material or it is a blade composed of a number of articulated MBP's. The preferred form of the pleats is a “V” shape, but it is not limited to any other shapes like stacking pleats. In the case the blade is made of a single sheet of a flexible material, it is considered the use of materials with an elasticity modulus and a restitution coefficient enough to make it return to its original shape after being bended, or the use of materials without elasticity properties such as fabric materials which return to its original position after being folded only by means of the movement coming from the follower displacement.

As the main objective of the present invention relates to increase the “working torque” of the rotor while minimizing the “returning torque”, embodiments one to four appeal to vary the blade area facing the flow, but there is a different approach to reach the same objective. The torque produced by a force on a rotor, depends also on the radial distance between the application of that force respect to the axis of the rotor. By displacing the position of the blade radially in order to increase its distance during the “working region”, it is obtained a higher working torque on the rotor, while decreasing this distance during the “returning region” it reduces the “returning torque” on the rotor, even while the area facing the fluid is kept the same. The fifth embodiment of the present invention appeals to this method to obtain a higher net output torque on the rotor. The same area of the blade facing the flow is displaced radially with respect to the rotor by two means, by lineal displacement and by rotation. In the linear displacement method, the blade itself is displaced radially along a low friction guiding element, while in the rotation method, the blade is rotated in order to locate it radially closer to the rotor during its pass through the “returning region” and to locate radially away from the rotor while passes through the “working region”. Both methods work with the same operating principle of the follower and guides to produce a controlled displacement of the blades by means of the rotor rotation itself as explained in the preceding embodiments.

The sixth embodiment of the present invention consists of a pair of “blocking deflector” and “acceleration deflector”, but with an additional functionality of the “blocking deflector”. In order to improve the pressure release on the recirculating flow on the “return region” of the turbine, it is included a series of communicating ducts between the two sides of the deflector, the “return side” and the “acceleration side”, which act suctioning the fluid on the “return region” because of a pressure drop caused by means of the Venturi Effect produced by the acceleration of the flow on convergent nozzles located on the “acceleration side” of the deflector. The communicating ducts are oriented in such a way that avoids the flow passing through the convergent nozzles to flow into the ducts and enter into the “return region” at the other side of the deflector, allowing flow from the “return side” to the “acceleration” side of the deflector. It is not discarded the use of check valves, but the preferred option is to use the geometry of the channel, the curvature, the changes in area, the angle orientation of the duct, and static or self-orientating movable lids.

The seventh embodiment of the present invention is mainly as described is a variable blade area turbine with a modification of the “blocking deflector” in shape and function in order to improve the flow of the recirculation flow on the “return region”. It is embedded on the “blocking deflector” one or more secondary rotating blade rotors (called SRBR) whose rotation axes are parallel to the axes of the turbine, with the blades of each rotor protruding out from both deflector sides in such a manner that when the blades passes through the “acceleration side” they are impelled by the flow, driving the rotation of its rotor, which makes the blades protruding on the “return side” of the deflector to move the fluid. The rotation of the SRBR occurs in counter direction to the turbine rotor, in order to make the fluid in the “return region” to circulate in the same direction of the turbine rotor rotation. The best use of the SRBR is to rotate synchronically with the turbine rotor, allowing the blades of the SRBR to “gear” not necessarily with physical contact but occupying the inter-blade space of the turbine blades, but it is not limited to rotate without any synchronicity. The SRBR can be mechanically connected through any mechanical transmission components to the turbine rotor or being independent. There is not a limit number of SRBR for each deflector, and it is also possible to mechanically engage several SRBR to each other in order to use some of them as driving turbine for the others, which would allow some of the SRBR blades to protrude only from the “return side”. The SRBR can also be attached to another power generation unit or electrical generator in order to use them as a secondary power source of the device. The SRBR can be a fixed area blade rotor or variable area blade rotor. This embodiment results more useful for turbines working on high density and viscosity fluids, for instance water or oil.

For the use of the variable area blade turbines and deflectors on water flows like rivers or channels, the preferred orientation of the rotation axis of the turbine is vertical, and the deflectors may work as a floating device, and the platforms besides their structural function may work to accommodate the fixed guide system for the follower guidance. The floating deflectors may be a solid body made of a low density material, but the preferred option consists in a hollow sealed body which can vary its floatation level by filling or emptying water from its internal chamber, with an opening or duct to allow the insertion or extraction of the liquid. The variation of the floatation level of the device is an advantage to regulate the power of the turbine, as it is proportional to the portion of the rotor submerged, and it is an particular advantage to adapt the device in rivers or water channels which variate its depth and flow due to seasonal changes, allowing to operate the same device at different flow levels. To increase the stiffness of the device, the preferred architectural option for the turbine device is to place two platforms, one of them above the water surface which allocate one of the fixed guide, the mechanic transmission and the electrical power generator, and the other platform submerged at the other extreme of the rotor axis, in order to make a sandwich keeping the deflectors between the two platforms. The submerged platform can allocate another fixed guide similar to the one located on the upper platform with respect to the trajectory, but not necessarily equal in the mechanism, because in the upper platform the components will work dry while in the bottom platform they will work permanently submerged. The guide and follower on the submerged platform use a mechanism to minimize the jams with plants and other debris typical of rivers.

For the use of the variable area blade turbines and deflectors on wind currents, there is not a preferred orientation of the rotation axis of the turbine, considering it may be vertical, horizontal or tilted at a particular angle respect to the current direction. However in all cases, the platform besides its structural and guidance function may work as an “aligning tail” to ensure the “working region” of the rotor is always facing the wind current direction, because the changes in wind direction along the operation of the device. It is achieved by a pivoting mechanism which allows to rotate the whole device around a pivoting vertical axis or the case of the horizontal axis turbine, or for the case of the vertical turbine axis, the pivoting device allows to rotate the only the platform with the deflectors attached to it or even the whole device. In the case of horizontal axis wind turbines the use of a variable blade area turbine has an additional advantage because it allows to have the rotor axis close to the ground while having blades extended on the “working region” which have a length much larger than the distance from the floor to the rotation axis. This represents simplicity and savings on the turbine installation because it is close to the ground.

The kind of fixture of the device will depend mainly on its size, the application, and kind of flow. In the case of a turbine located on a water channel or river, it can be fixed statically to the floor of the channel in the case of a non-floating device, or it can be a floating device anchored to spots in land, dockets, dams, floating platforms, ships, or underwater fixings by means of cable or bars. In the case of the floating devices it can be used the anchoring cables to create a protecting mesh upstream of the device in order to deflect any voluminous debris that could damage the device.

The anchoring of wind turbines will depend on the axis orientation, but all of them are allowed to rotate around the pivoting axis, to relocate according to the wind direction. For vertical axis turbines the preferred option is that the pivoting axis is concentric with the turbine rotor, but it is not limited to an eccentric configuration.

The variable area blade turbines and deflectors disclosed for the present invention can be arranged in order to increase the overall power generation capability. The best arrangement consists in placing the turbine rotors in parallel, in such a manner that the current may flow equally on each without obstructing the other. This arrangement has the advantage of sharing the deflectors between consecutive turbines, in such a manner that a same deflector can use its “acceleration side” on one turbine and its “return side” on the contiguous one. The single turbine is conceived as a modular device consisting of a blade rotor, at least one deflector, the platforms with the fixed guides, the mechanical transmission and the power generation unit. Those modular devices can be attached one aside the other taking advantage of the common deflectors and sharing the anchoring. A variation of this arrangement is placing the consecutive turbines to rotate in counter direction, with the same concept explained on the seventh embodiment, but with each turbine acting as an independent power generation unit.

The turbines may be designed with either a clockwise rotating rotor or a counter-clockwise rotating rotor, understanding that the deflectors will be located at the opposed side of the rotor for each rotation direction.

It is possible to create a power generation devices by combining part or all of the methods exposed on the different embodiments of the present invention, either to variate the blade area of the rotor or for conditioning the flow, understanding that those possible combinations are contemplated in the spirit of the present invention. The present invention is intended to be used on any kind of density and viscosity fluid, not limited to the electrical power generation matters, but also being possible to use as a turbine to supply mechanical power required to drive any artifact or process.

All of the constructive elements of any of the embodiments presented are modular and separable which makes them easily stackable and transportable by river boats for long distances in case of use on remote locations.

There is not a fixed dimension for any of the elements nor a number of blades of the rotor, or of the movable blade parts in each blade, understanding that the higher the overall extended blade area on the “working region” and the larger the rate between the extended blade vs the contracted blade will be proportional to the force obtained the force obtained from the fluid current, considering that larger pieces represent disadvantages to manufacturing and transportation of such elements, and that the higher the number of movable parts in the assembly will increase the mechanical complexity and the risk of failure of the system.

### BRIEF DESCRIPTION OF THE DRAWINGS

FIG. 1 is a general perspective view of a water turbine with variable area blades with a vertical clockwise rotation rotor with one static blocking deflector.

FIG. 2 is a front view of a water turbine with variable area blades with a vertical oriented rotor with one static blocking deflector, placed floating on a water channel.

FIG. 3 is a front view of a water turbine with variable area blades with a vertical oriented rotor with one static blocking deflector, placed anchored to the soil of a water channel.

FIG. 4 is a general perspective view of the variable area blade turbine operating in wind currents.

FIG. 5 is a front view of the variable blade area turbine device operating in wind currents with the inlet of the turbine facing the wind current.

FIG. 6 is a top view of the variable blade area turbine device operating in wind currents oriented with the wind current without the back platform.

FIG. 7 is a cross section view of the first embodiment of the variable blade area rotor showing the variation of the area of two diametrically opposed blades by the nesting method.

FIG. 8 is a perspective view of the variable area blade turbine rotor with four blades and two MBP and one FBP per blade.

FIG. 9 is a top view of a variable area blade turbine only with the rotor of four blades, the blocking deflector, the base platform, and the fixed guide located on a fluid flow.

FIG. 10 is a cross section view of the second embodiment of a variable blade area turbine showing two diametrically opposed blades using the internal area variation method.

FIG. 11 is a cross sectional view of the second embodiment of the variable area blade turbine showing two diametrically opposed blades using the internal area variation method by rotation.

FIG. 12 is a perspective view of a rotor of a variable area blade turbine composed of four blades combining the nesting method and the internal area variation method.

FIG. 13 is a partial perspective view of a variable area blade turbine with a rotor composed of four blades combining the nesting method and the internal area variation method, showing the base platform with the power generation unit, the fixed guides and their followers.

FIG. 14 is a cross sectional view of the third embodiment of the variable area blade turbine showing two diametrically opposed blades using the area reorientation method.

FIG. 15 is a cross sectional view of the third embodiment of the variable area blade turbine with the MBP's own longitudinal rotating axis perpendicular to the rotor axis.

FIG. 16 is a partial perspective view of the variable area blade turbine of four blades with deflectors for flow conditioning with curved blades using the reorientation method of the third embodiment as shown in FIG. 14, combined with the nesting method of the first embodiment as shown in FIG. 7.

FIG. 17 is a plant view of the turbine device with the same rotor exemplified on the FIG. 16.

FIG. 18 is a plant view of an example of the third embodiment of the present invention with a four blades rotor rotating on the indicated clockwise direction, with every blade permanently rotating in the same direction.

FIG. 19 is a partial perspective view of the same exemplification of the third embodiment of the present invention shown on FIG. 18 showing the fixed guides and follower mechanism

FIG. 20 is a partial perspective view of an example of a four blade rotor of the fourth embodiment of the present invention.

FIG. 21 is a partial plant view of the four blade rotor of the fourth embodiment of the present invention as shown in FIG. 20 including the platform, the fixed guides and the blocking deflector.

FIG. 22 is a partial perspective view of the same device shown in FIG. 21 without the blocking deflector, showing the power generation unit, the platform and the fixed guides.

FIG. 23 is a cross sectional view of an example of turbine of the fourth embodiment of the present invention showing two diametrically opposed blades at minimal area and maximal area point.

FIG. 24 is a cross sectional view of an example of turbine of the fifth embodiment of the present invention showing two diametrically opposed blades at closest and farthest position of the blade area respect the rotation axis.

FIG. 25 is a cross sectional view of an example of turbine of the fifth embodiment of the present invention showing two diametrically opposed blades at closest and farthest position of the blade area respect the rotation axis.

FIG. 26 is a detail perspective view of the static deflector of the sixth embodiment of the present invention using the Venturi principle.

FIG. 27 is a plant view of the sixth embodiment of the present invention.

FIG. 28 is a plant view of the seventh embodiment of the present invention.

FIG. 29 is a plant view of the present invention with a modified platform with perforations distributed along the return region.

FIG. 30 is a detailed cross sectional view of one of the perforation of the platform of FIG. 29 with the unidirectional mechanism of flow.

FIG. 31 is a plan view of an array of three parallel variable blade area turbines.

FIG. 32 is a perspective view of a particular application of the present invention when working as a floating turbine located on water channels or rivers.

FIG. 33 is a detailed cross sectional view of an example of the submerged fixed guide with its corresponding follower for the device of FIG. 32.

FIG. 34 is a front view of the floating water turbine described on FIG. 32 with an anchoring system to the river bed.

FIG. 35 is a perspective view of the floating water turbine described on FIG. 32 with an anchoring system attached to elements on the riversides.

FIG. 36 is a perspective view of the floating water turbine described on FIG. 32 with an anchoring system attached to elements on the riverbed and riversides combined.

### DETAILED DESCRIPTION OF THE INVENTION

The following figures are not to scale. The actual dimension and/or shape of each of the device components may vary. Only important details of the device are shown, however one of ordinary skill in the art can appreciate how the overall device may be constructed, without undue experimentation. As the main function of the device relates to transforming the kinetic energy of a fluid flow into a torque on a rotating rotor turbine, where such rotor is fully or partially immersed on the fluid, with its axis oriented perpendicular to the flow direction, composed mainly by planar, curved or spiral blades, radially distributed and spaced from each other. The present invention considers that each blade may be composed of some fixed parts called in the present disclosure as FBP which will act as a frame for other movable parts called MBP, which can variate their relative position respect to the FBP. Each blade will be at certain moment of its rotation being propelled by the fluid flow, moving on the same direction, in the region called the “working region”, while on other moment of the rotation will move in opposite direction to the fluid, while passing through the “return region”. In the same way, every instant in the rotation of the rotor, all the blades passing through the “working region” are called the “working blades”, while the blades passing through the “return region” are called the “returning blades”. The “working blades” transmit the force from the fluid generating a “working torque” on the rotor, while the “returning blades” receive a non-desired torque called the “drag torque” which opposes to the “working torque” reducing the net output torque of the rotor.

The number of blades, MBP and FBP used in the description and drawings of the present invention is purely for exemplification purposes, being possible to have number of each of those elements from a single unit up to a not fixed number, dependent of the size of the turbine and the complexity desired of the system.

The method disclosed in the present invention can operate in fluids of different density and viscosity, so for the purposes of the present description it will be frequently represented like devices operating in water currents on channels or rivers, and Eolic devices operating on wind currents, but the application of such methods are not limited to those fluids.

For all of the drawings explained in this document, the three parallel arrows represent the direction of the water current, while the single arrow either linear or curved means the displacement or turning direction of the element close to such arrow.

The present invention discloses several methods to vary the blade area in a controlled manner in order to either increase the “working torque” or decrease the “drag torque” of the turbine, grouped on embodiments one to five, and three different conditioning flow methods described in embodiment six to eight, with the same purpose of increase the efficiency of the turbine. Each figure shows which kind of method for area variation is used as well as the kind of deflector for flow conditioning displayed. As one of the objectives of the present invention is to provide a modular device for power generation, combination of such modules consisting of constructive elements, rotor blades using any of the area variation method or combination of them, and deflectors for flow conditioning it is not considered a new embodiment every the combination of them in type or number, being each embodiment presented only a exemplification of the method of controlled area variation or conditioning flow, understanding that any possible combination is included on the spirit of the present invention.

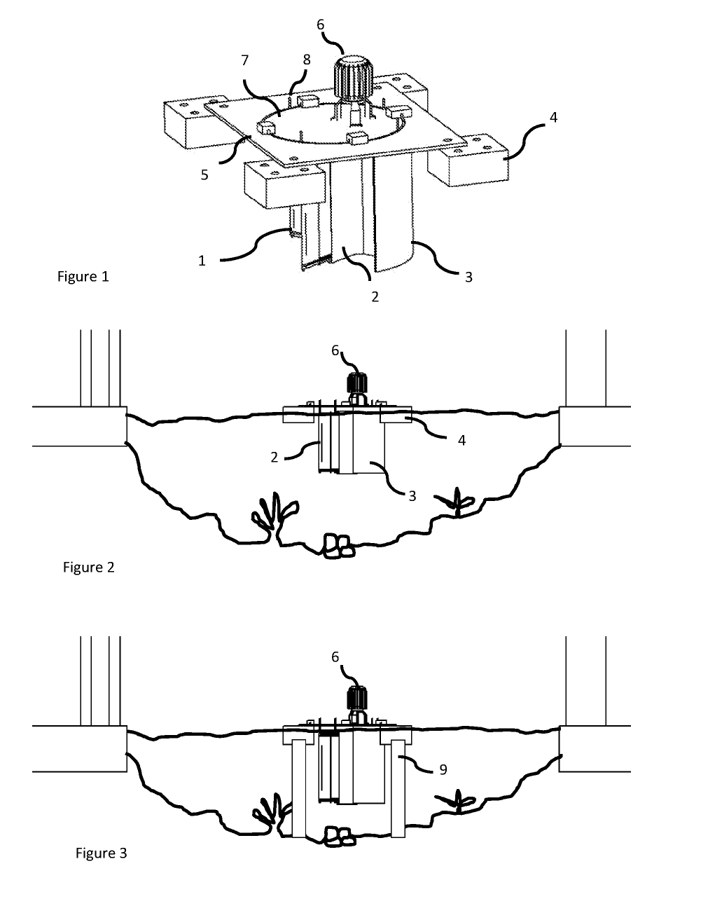

FIG. 1 is a general perspective view of a water turbine device with variable area blades 1 of any kind with a vertical clockwise rotation rotor 2 with one static deflector 3. All the devices disclosed by the present invention are composed by the floating or anchoring element, which for the case of FIG. 1 correspond to four floating bodies 4, which may be, present in different quantities depending on the weight and size of the device, the floating platform 5, which could be accompanied by another immersed platform not present on FIG. 1. The floating platform is preferably above the water surface, but not limited to it, and allocates the power generation unit and the mechanical transmission 6, and the fixed guide 7, which will restrain the movement of the follower 8 attached to the blades along the rotation of the rotor. The guide 7 describes a curve on the platform which can be contained on the flat plane of the platform as shown on FIG. 1, representing the axis X and Y in a representative Cartesian Coordinate System or can represent a three dimensional curve protruding from the platform, allowing to produce a movement of the follower on a perpendicular direction to the platform in addition to the movements on the plane of the platform, having mobility in directions X, Y and Z of the mentioned Cartesian Coordinate System. The guide and follower pair may be any known type of mechanical guidance systems, like bars and bearing, slider, crown toothed rack and pinion or like the one shown for purpose of exemplification in FIG. 1 comprising grooves for the guide 7 and sticks 8 passing through the groove. The device is placed on the water current, being the deflector 3 the most upstream element of the device having mainly the function of blocking the contact of the current with a portion of the rotor corresponding to the half of the rotor where the blades move in counter current direction, called the “returning blades” describing an area called the “return region”, and at the same time, the deflector also creates a flow acceleration at the inlet of the turbine because the convergent geometry, in order to maximize the energy transference from the flow to the rotor in the area described as “working region”, because of the impelling effect or pushing action of the flow over the blades that move on the same direction of the flow, called the “working blades”, describing a region called the “working region”.

FIG. 2 is a front view of a water turbine as shown in FIG. 1 with variable area blades with a vertically oriented rotor with one static blocking deflector, placed floating on a water channel. The floating effect may be produced by means of the floating bodies 4 or by means of the deflector 3. This is the preferred use for the variable area blade turbine when working on water currents. The rotor 2 can be completely or partially immersed on the water, being possible to regulate how deep is immersed the rotor by increasing or decreasing the floatability of the device, mainly by adding or removing floating elements 4 or varying the weight or density of the floating elements 4 and deflectors 3, which preferably can be made by adding or removing water from them. The more length of the rotor is immersed into the fluid, will represent the more power the turbine can generate, so the variation of the floating level of the device is a method to regulate power, totally immersed being the highest power level setting. The main advantage of this floating system relays on having always the mechanical transmission elements and power generation unit 6 out of the water, what makes it more simple and reliable while less expensive. The floating device is also more robust to allow continuous operation during rises or lowers of the water level because of seasonal changes. There is an alternative configuration to the floating system explained on the FIG. 3.

FIG. 3 is a front view of a water turbine with variable area blades with a vertically oriented rotor with one static blocking deflector, placed anchored to the soil of a water channel. The device is anchored to the river or channel bed by means of at least one column, pillar, post or any other structural member 9 capable of maintaining the position of the turbine in the river. The column 9 is provided with a mechanism to adjust the height of the turbine respect to the channel bed or soil, in order to ensure the mechanical transmission and the power generation unit 6 is out of the water, and even to allow operation when sedimentation of the soil occurs. The use of the variable area blade turbine is not limited to the systems where the power generation unit is above the water, being possible to have immersed power generation units and mechanical transmissions. The vertical orientation of the rotor is the preferred application for the variable area blade turbine operating in water channel or river because it allows having long rotors, taking advantage to the depth of such water channels. The application of this device in water channels is not limited to the vertical rotor orientation, but in the case of horizontal rotor orientation turbines, it would be more useful to have a rotor with only the “working blades” immersed on the water, while the “returning blades” are out of the water, avoiding the “drag torque” that makes the present invention of higher utility. However, the use of variable area blades in horizontal rotor turbines is useful when working with arrays of parallel immersed rotors, placed mainly one over the other, not necessarily aligned, in order to take advantage of the benefits of the flow conditioning of the combined system and the maximum use of the available space.

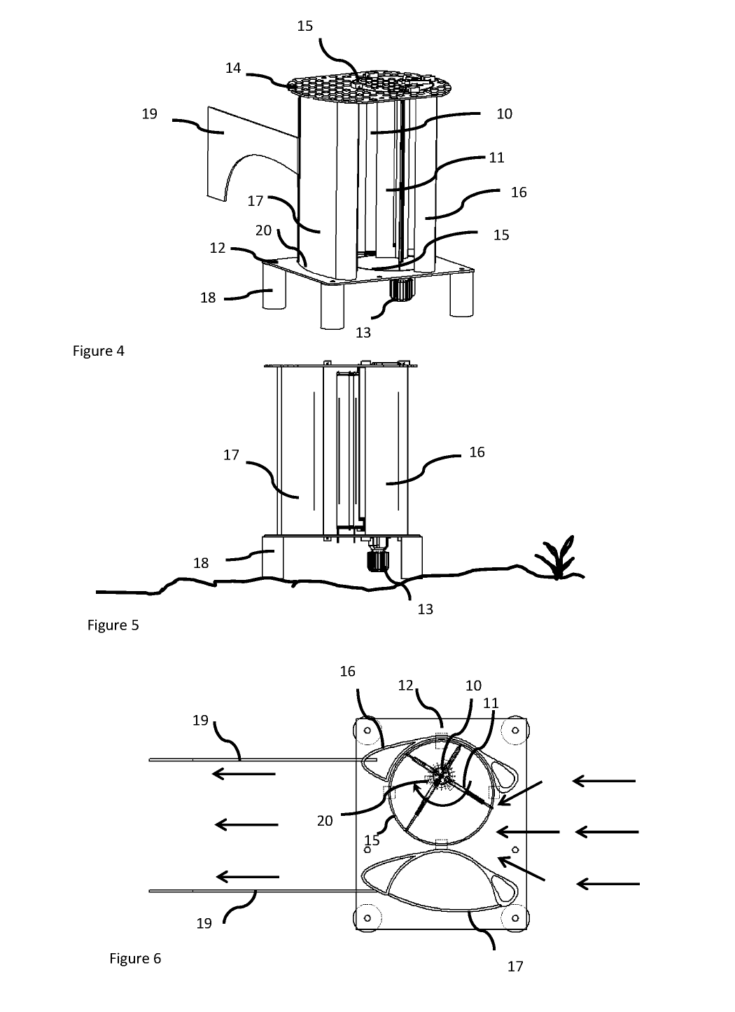

FIG. 4 is a general perspective view of the variable area blade turbine configured to operate in wind currents. The device is composed by the rotor 10 with the variable area blades 11 with a base platform 12 where the mechanical transmission and power generation unit 13 are attached for exemplification purposes, and a back platform 14, both platforms bearing the rotor, serving as structural members to the system, allocating the fixed guides 15 for the followers of the blades 11. The power generation unit and mechanical transmission 13 can be attached either to the base platform 12 or to the back platform 14, being the preferred option the base platform 12 because it is close to the ground or fixation surface which makes easier any manipulation of the components. The system is composed also by the blocking deflector 16 which covers part of the rotor 10 corresponding to the “return region” and the inlet deflector 17, with a convergent area geometry in charge to accelerate the flow as it enters in contact with the “working blades”. The deflectors 16 and 17 act also as structural members which holds together the platforms 12 and 14. The system is located in ground or on the working surface by means of the anchoring elements 18, which are represented in the FIG. 4 by four circular columns for exemplification purposes only, but those anchoring elements can be also composed by any number of single elements, with any possible section, or geometry, or being composed by a any type of frame or resistant structure in order to keep the device in position. One of the main differences of the device operating in constant direction flow, for instance water channels or rivers, and variable direction flows like wind or maritime currents, is that the latest require a reorienting mechanism to ensure the inlet of the turbine, and so the determined “working region” of the rotor is always oriented with the flow direction. In FIG. 4 there is a tail element 19 attached to the structure of the device that combined with a pivoting mechanism 20 located on the base platform 12 allows the device to rotate in order to reorient in such a manner that the tail element 19 gets aligned with the flow current lines. The tail element 19 is represented by a kind of rectangular flat region joined to the body of the turbine by means of a narrow bridge element with a curved shape in FIG. 4 for exemplification purposes, but it can be of any other form that provides low weight, an extended area which will be pushed by the wind, located as far as possible from the body of the turbine in order to produce a high torque to produce the rotation with the pivot mechanism 20. The pivot mechanism 20 makes possible the device or part of it to rotate in order the turbine inlet is oriented facing to the wind current.

The base platform 12 and the back platform 14 can be a continuous solid surface or can be provided of orifices in determined areas in order to ease the evacuation of the fluid at the end of the working region of along the return region.

FIG. 5 is a front view of the variable blade area turbine device operating in wind currents, with the turbine inlet formed by the inlet deflector 17 and the blocking deflector 16 facing the flow direction. The anchoring element 18 keeps the device in position and leaves room for the power generation unit and mechanical transmission 13.

FIG. 6 is a top view of the variable blade area turbine device operating in wind currents, without the back platform, oriented with the wind current by means of the tail element 19 in this case formed by two separated elements attached to the body of the turbine in the outlet region of the fluid. The tail element 19 can be formed from one up to a not determined number of elements, with the possibility of being either separated elements attached to the device or a prolongation from the inlet deflector 17 or the blocking deflector 16. The preferred position of the tail element 19 is in the outlet region of the fluid, meaning downstream from the device, but it is not limited to be placed on the inlet region of the device, meaning upstream, or being located over or below the device on the base platform 12 or back platform 14. The position of the tail element or elements 19 is such that the force of the fluid over it when they are not parallel be the highest possible to produce the rotation of the device over the pivoting mechanism 20. The location of the rotation point may be coincident with the axis of the turbine rotor or not, being the preferred option to be coincident with the gravity center of the device in order to require the same torque to produce the reorientation in both directions. The FIG. 6 shows a rotor 10 composed of for variable area blades 11 which rotate in clockwise direction, producing the change in area because of the restraint of a prat of each blade 11 called the follower to move over the fixed guide 15. The wind current is represented by three parallel arrows with leftward orientation located at the right of the device which is conducted in a convergent turbine inlet formed by the inlet deflector 17 and the blocking deflector 16.

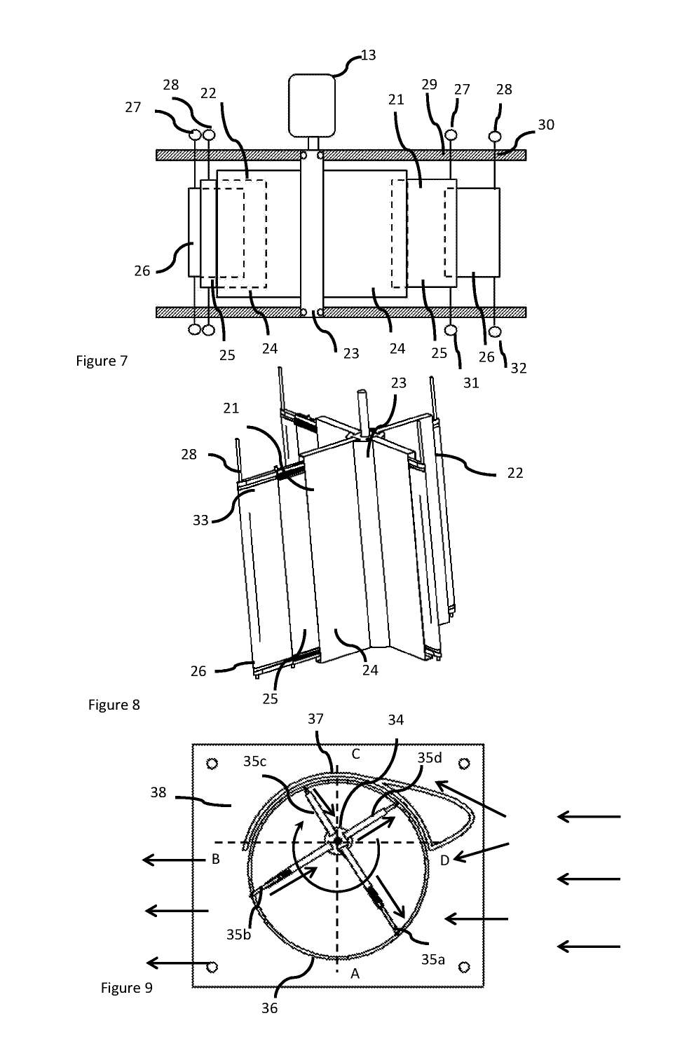

Independently from the location of the device or the type of fluid to work with, there are five different methods of blade area variation, which are explained on embodiments one to five. FIG. 7 is a cross section view of the variable blade area rotor showing the variation of the area of two diametrically opposed blades by the nesting or telescopic method. The rotor may be composed from two blades up to a not determined number, but for the purpose of explanation of the method only two diametrically opposed blades are shown, blade 21 which is at the maximum deployed area and blade 22 which is contracted to its minimal area. The rotor is composed by a spindle shaft 23 and some elements of the blade attached to it called the fixed blade part (FBP) 24. The FBP's 24 can also be part of the spindle shaft 23. There are other elements of each blade which will be able to move called the “movable blade parts” (MBP) 25 and 26. The method consists in displace any MBP of each blade in radial direction of the rotor in order to extend as far as possible to create a big area as in blade 21, where the MBP 26 and 25 are completely out and not being hidden by any other blade element, and being contracted gradually as the rotor turns to reach a minimum area as seen in blade 22, where the MBP 26 is hidden by the MBP 25, and this is hidden at the same time by the FBP 24. FIG. 7 uses for exemplification purposes one FBP and two MBP for each blade, but it is not limited to it, because the number of MBP can be from one up to a not determined number, understanding that the greater the number of MBP will benefit because the larger the area when extended, but also understanding that as more MBP elements per blade the probability of failure of the system also increases, and also could difficult the contraction process. The displacement of the MBP 25 and 26 is produced because of the movement of the follower 27 and 28, which are restrained to move over a guide element 29 and 30. As the rotor rotates, the blade have an angular displacement which makes the follower attached to it to displace radially relatively to the rotation center, producing a relative movement between the MBP attached to it and its contiguous blade element. FIG. 7 uses for exemplification purposes one follower per each MBP, but it is not limited to it, being possible having just one follower for several MBP. Also FIG. 7 shows an upper follower 27 and a bottom follower 31 for the MBP 25, and upper follower 28 and bottom follower 32 for MBP 26, for exemplification purposes, not being limited to it, because it could be used only one follower per MBP.

FIG. 8 is a perspective view of the variable area blade turbine rotor with four blades, with a spindle shaft 23, and each blade being composed of one FBP 24, and two MBP 25 and 26, showing the different position of the MBPs of each blade. The displacement of the MBP 25 on the FBP 24 and the displacement of the MBP 26 on the MBP 25 is guided by means of a guidance system 33 that ensures that the MBP 25 stays in a stable position with low friction displacement. The geometric configuration shown in FIG. 7 and FIG. 8 in which the more external MBP elements are smaller than the elements located closer to the spindle shaft 23, meaning the element 26 smaller in the axial direction than the element 25 and the element 25 smaller in the axial direction than the FBP 24, is only one of the possibilities of application of the nesting method, because it is also possible to have the bigger size elements in the more external radial positions, or even all the elements of similar size, in the axial direction. Considering that the torque produced because of the force of the fluid impelling the blades will be proportional to the size of the area and the distance of this area from the rotation axis, physically it makes the preferred option the one in which the outer elements have the largest area, in FIG. 8 it would mean the element 26 being larger than the element 25 in the axial direction, and this one larger than the FBP 24 in the axial direction. With respect to the way how the MBP elements 26 and 25 are hidden when they displace to contract the blade area, it may occur making the smaller elements to drive into the bigger elements or it can also occur by placing one element aside the other externally. Also combination of both methods is useful in cases when there is a large number of MBP per blade. FIG. 8 shows the first case of the smaller element 26 getting into the element 25, and both getting into the FBP 24. With respect to the follower to produce the relative displacement between the MBP 26 and 25 themselves and the FBP 24, it is possible to provide one or more followers per each MBP, or it is possible to provide a single follower 28 to produce the displacement of all the MBPs as shown in FIG. 8. This method implies the guiding mechanism 33 to have some protruded elements to drag one MBP with the displacement of its contiguous MBP once it reaches the most extended or contracted relative position between them.

FIG. 9 is a top view of the first embodiment of a variable area blade turbine with only the rotor 34 of four blades 35a, 35b, 35c, 35d using the telescopic or nesting method, the blocking deflector 37, the base platform 38, and the fixed guide 36 located on a fluid flow. The rotor 34 rotates in clockwise direction as the fluid flows leftwards. The area swept by the four blades 35a, 35b, 35c and 35d attached to the rotor 34 is delimited by the circular curve in this case coincident with the fixed guide 36. There are four quadrants identified in that area, being the two quadrants limited by the curved segment DAB corresponding to the called “working region” because it is the region where the flow produce a force on the blades in the desired direction of rotation of the rotor, generating the working torque on the rotor. The two quadrants descripted by the curved segment BCD is called the “return region” in which the blades are not being moved by the flow, even receiving a force by the fluid in opposed direction to the desired rotation of the rotor, generating a opposed torque in the rotor, called the drag torque. Every blade on the rotor will pass alternatively for the working region and the drag region every rotor turn. The purpose of the area variation methods disclosed on the present invention is to make every blade increase its area or increase the radial distance of such area to the rotor axis when passing through the working region in order to maximize the working torque on the rotor, and decrease the area or its radial distance when passes through the return region in order to minimize the drag torque on the rotor. The point of maximum area or maximum radial distance is intended to occur when the blade passes on point A, called the thrust point, where the blade or its projected area in perpendicular direction to the flow is maximum with the least radial displacement, but it is not limited to other cases where the maximum projected area in perpendicular direction of flow is achieved in other points of the working region for any particular constructive or fluid dynamics interest. The point that determines the end of the return region and the start of the working region is the D point called the neutral upstream point. During the return region and before reaching the D point, the blade is intended to face the minimal resistance to movement, and once it passes on point D it is desired to face the maximum area and radial distance. All along the pass through the working region, it is intended that the blade be capable of transmitting the most energy from the fluid to the rotor by means of the maximum projected area in perpendicular direction of the flow and radial distance, and reduce such area or distance once it passes through the point B called the neutral downstream point, where it starts the return region. All along the return region it is intended that the blade area projected in radial direction or the radial position of such areas be the minimal in order to minimize the resistance to the movement. In this region it is more important the projected area in radial direction than in the perpendicular direction to the flow because of the effect of the blocking deflector 37. In case no deflector is placed, the important direction of area reduction should be perpendicular to the flow. The point C called the drag point is located diametrically opposed to the point A or thrust point, and it is intended to be the point where the maximum effort of area reduction or radial position is required.

The nesting mechanism in the first embodiment increases the blade area along the working region by displacing radially outwards the MBPs, and reducing the area by displacing radially inwards the MBPs, all along one rotation of the rotor, by means of the restraining of the follower on the fixed guide 36.

The fixed guide 36 is represented with a closed curved similar to a circle, but not limited to this geometry, eccentric respect to the rotor axis. The eccentricity is the factor that produces the relative movement of the MBPs, because the FBPs are restricted to move describing a hypothetical concentric circle with the rotor axis, and then for every angular displacement of the rotor, the distance between the MBP and its colliding FBP will be proportional to the distance between the curve of 36 and the mentioned hypothetical concentric circle in a radial direction, and this distance increases on the working region and decreases on the return region. FIG. 9 shows a single fixed guide, which implies that there is a single follower per each blade. There is not a limit of followers per blade, but it is intended to have as maximum one follower per MBP of each blade, and the same number of fixed guides as followers in a single blade.

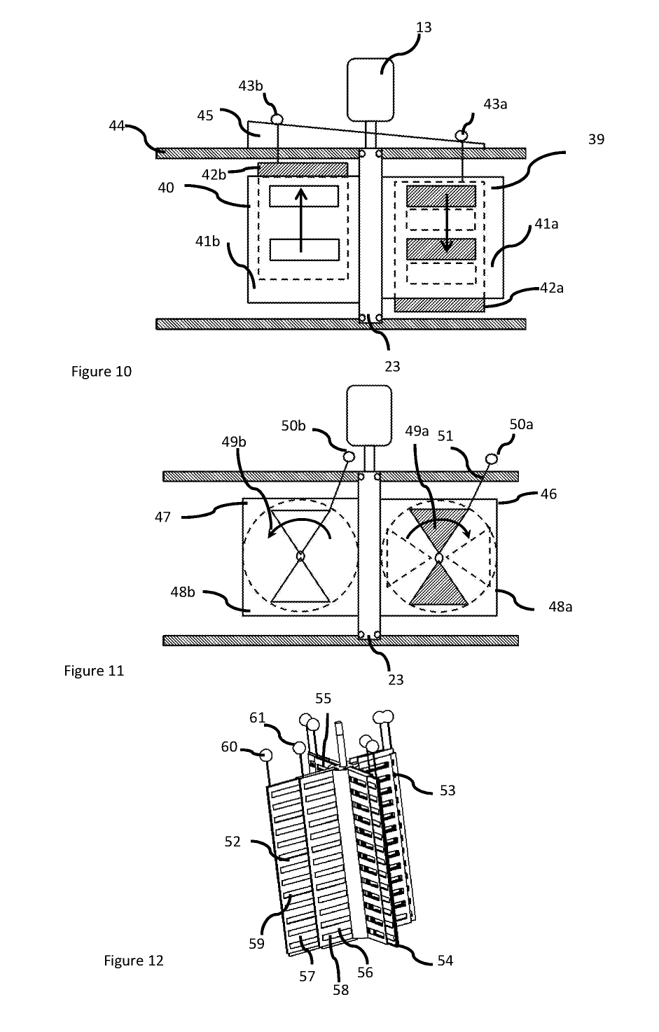

FIG. 10 is a cross section view of the second embodiment of a variable blade area turbine showing two diametrically opposed blades using the internal window opening method. The two blades in FIG. 10 are blade 39 which is located at the right of the rotor shaft 23, which is facing the maximum area to the flow, and the blade 40 diametrically opposed to 39, which presents less area to face the flow because the opening of two windows on the blade body. Each blade is composed by a FBP 41 and at least one MBP 42, both blade parts having two openings called windows, in this figure represented by two rectangular areas for exemplification purposes, but being possible to have any possible geometry and not restricted to a particular number. To create the maximum blade area effect in blade 39, the MBP 42a is displaced in such a manner that the windows on the FBP 41a are covered by solid geometry of the MBP 41a, creating together an almost continuous face without openings. The windows on the MBP 42a are also covered by the solid body of the FBP 41a. In the blade 40, to create the minimal area, the relative displacement of the MBP 42b with respect to the FBP 41b, makes that the openings in both MBP 42b and FBP 41b get aligned leaving two internal windows in the blade 40. FIG. 10 represents a lineal vertical displacement of the MBPs 42, but the method is not limited to this kind of linear displacements. The MBPs 42 have a follower element 43 attached to them, 43a on the blade 39 and 43b on blade 40, restricted to move on a fixed guide around the rotation axis of the rotor, as explained for the first embodiment of the present invention, but with the difference that to produce the vertical movement of the followers 43a and 43b, and of the MBPs 42 attached to them, the guide must describe a three dimensional curve, concentric or eccentric respect to the rotation axis, making the follower to displace perpendicular to the plane of the base platform 44, represented in FIG. 10 with the inclined wedge like guide 45. The transition from the closed window blade 39 to the open window blade 40 occurs by means of the rotation of the rotor, which makes the follower 43a to pass from a lower position to the high position occupied by follower 43b. Every rotation of the rotor, each follower and its attached MBP will describe and upwards and downwards movement as they rotate.

The method of area variation described in the second embodiment can also be applied as shown in FIG. 11, which is a cross sectional view of the second embodiment of the variable area blade turbine showing two diametrically opposed blades using the internal area variation method as explained in FIG. 10, but with the variation of opening or closing the windows by means of rotation of the MBP. The blade 46 located at the right of the rotor shaft 23 is facing the maximum area to the flow, and the blade 47 diametrically opposed to blade 46, which presents less area to face the flow because the opening of two windows in the blade body. In this case the MBPs 49 are represented by a disc like element which rotates around its center in order to cover the triangular openings on the FBPs 48 on the blade 46, and to leave two triangular openings on the blade 47 by aligning the triangular openings on the MBP 49 with the triangular openings on the FBP 48. The geometries of the openings, the disc shape of the element 49, the point of rotation of the MBP 49 and the number of openings of each element are for exemplification purposes, understanding that the method can be applied to any number of openings of different geometries, even with a different number of MBP per each blade, rotating on points not necessarily the geometric center, with the elements not necessarily radially distributed. The follower 50 moves on a fixed guide 51 which can be flat or three dimensional, describing eccentrically positions around the axis of the rotor shaft 23.

FIG. 12 is a perspective view of a rotor of a variable area blade turbine composed of four blades combining the nesting method and the internal area variation method. The combination of different methods of area variation is not presented as a separate embodiment, but it is considered as an application of the preceding embodiments on the spirit of the present invention because it increases the area variation rate between different positions of the blade along the rotation of the rotor with respect to the application of each methods separated. FIG. 12 shows blade 52 at its maximum area position, being composed of one FBP 56 and three MBP, one MBP 58 displacing vertically on 56, which is in charge of closing the windows on the FBP 56, other MBP 57 which displaces telescopically respect to 56, and another MBP 59 which moves vertically on the MBP 57, in charge of closing the windows on it. This system uses two followers per each blade, being the outer follower 60 attached to the MBP 59, and the inner follower 61 attached to the MBP 58. The outer follower 60 has two functions, displace the pair of MBPs 57 and 59 radially respect to the FBP 56, and at the same time displace vertically the MBP 59. The inner follower 61 displaces the MBP 58 vertically respect to the FBP 56. It can be seen on FIG. 12 how blade 52 shows the MBP 57 extended with its windows closed by the MBP 59 and the FBP 56 with its windows closed by the MBP 58, while the diametrically opposed blade 53 has fairly only visible the FBP with the telescopic MBP hidden on it, and both with all the windows opened. Those blades 52 and 53 at that specific moment represent the maximum area and the minimum area stages respectively. The other blades of the rotor at that particular moment are in a transitional stage, where the blades passing through the working region will show a higher area than the ones passing through the return region.

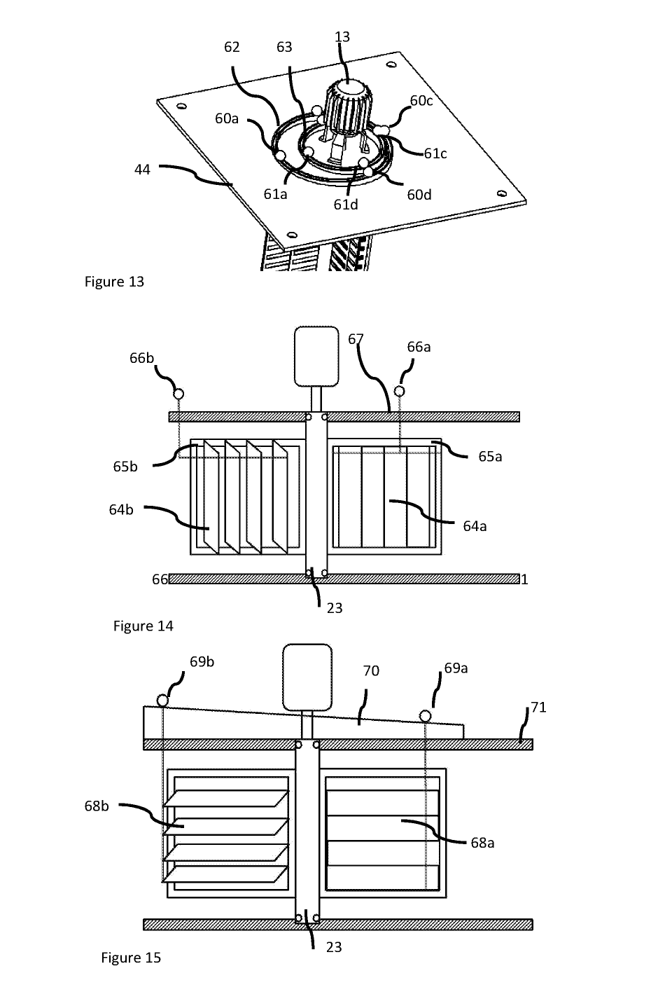

FIG. 13 is a partial perspective view of a variable area blade turbine with a rotor composed of four blades combining the nesting method and the internal area variation method as shown on FIG. 12, showing the base platform with the power generation unit and mechanical transmission 13, the fixed guides 62 and 63 and their followers 60 and 61. The outer follower 60 and the inner follower 61 of each blade is shown in the positions identified as “A” or “thrust point”, “D” or “upstream neutral point” and “C” or “drag point”. As the “thrust point” is the one with the maximum area extension of the blade, there is a radial direction separation between the outer follower 60a and the inner follower 61a, which produces the relative radial displacement of the MBP on that associated blade. As the rotor rotates, the followers change their relative position, between them and also in normal direction respect to the plane of the base platform 44, which produces the displacement of the MBPs on the axial direction of the rotor, meaning perpendicular to the plane of the base platform. This axial movement produces the open and closing of the windows on the blade. To make the follower displace in this normal direction to the base platform 44 or axial direction of the rotor, the outer fixed guide 62 and the inner fixed guide 63 must have the associated geometry to produce such displacement, represented in FIG. 13 as an inclined curved body. For exemplification purposes, the followers are represented as spherical bodies moving on inclined ramps, but the guidance system of followers may be composed of any mechanical known guidance system, warranting the restraint of the follower and minimizing friction as it moves.

FIG. 14 is a cross sectional view of the third embodiment of the variable area blade turbine showing two diametrically opposed blades using the area reorientation method. This method consists on having MBPs 64a and 64b with flat or airfoil like shape on each blade, rotating on its own longitudinal axis relative to the FBP 65a and 65b which bears their shaft in such a manner that during the pass of the blade through the “working region”, the MBPs 64a on the blade located rightwards to the spindle shaft 23, rotate to face the flow with the wider area, closing the pass of the flow between them, in a similar way to a blind curtain when it is closed to avoid the light to pass thru, maximizing the force of the fluid on that blade, and the MBP's 64b facing the flow with their thinner side, to allow the flow to pass through them, showing the blade at this point the minimal resistance to move. The movement of the MBP 64a and 64b is made by the radial displacement the followers 66a and 66b with respect to the spindle shaft 23, changing this radial distance along the turn of the rotor because the restriction of those followers to move along a fixed guide 67, which for this particular configuration of parallel rotating axis of the MBPs 64a and 64b and the spindle shaft of the rotor, could describe a flat XY geometry.

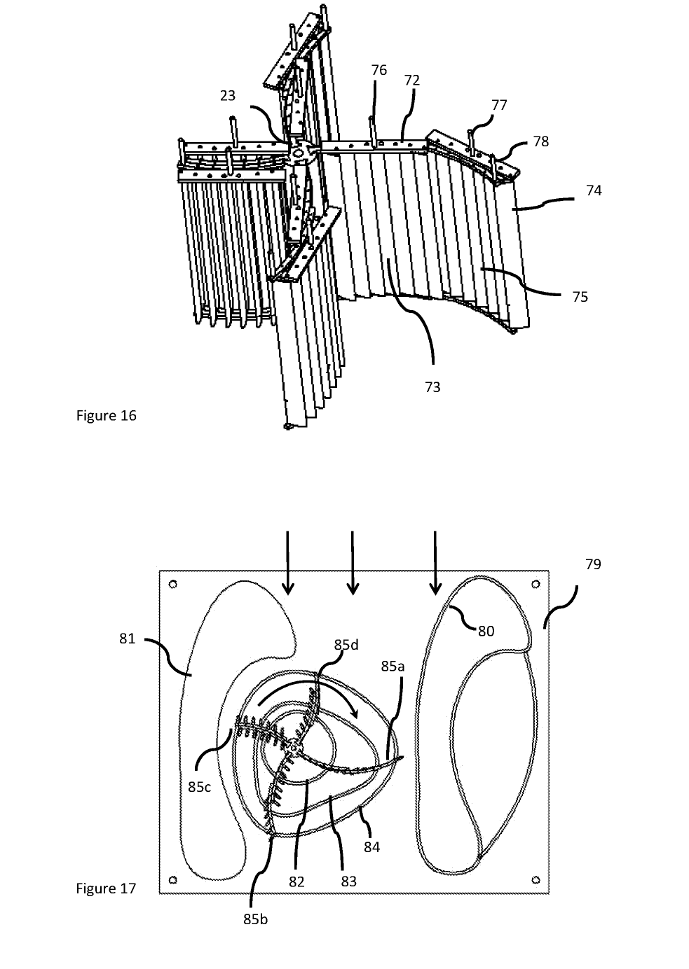

FIG. 15 is a cross sectional view of the third embodiment of the variable area blade turbine but unlike the FIG. 13 shows the MBP's 68a and 68b with its own longitudinal rotating axis perpendicular to the spindle axis 23 of the rotor. The rotation of the MBPs 68a located in “closed” position and the MBPs 68b located in “open” position is produced by the vertical relative displacement of the followers 69a and 69b respect to the FBP 71a and 71b, and that vertical displacement is produced by the restrained movement of those followers on an inclined guide 70 as the rotor turns. As a general rule of displacement of the followers for the third embodiment of the present invention, it must be perpendicular to the orientation of the rotation longitudinal axis of the MBPs, in this case it is achieved by an inclined guide 70 respect to the platform 71. For this specific example it is not required the relative radial displacement of the followers 69a y 69b respect to the spindle axis 23, but it can be made combination of both radial and perpendicular movements to achieve the objective of reorienting the area of the MBPs.

FIG. 16 shows a partial perspective view of the variable area blade turbine of four blades with deflectors for flow conditioning with curved blades using the reorientation method of the third embodiment as shown in FIG. 14, combined with the nesting method of the first embodiment as shown in FIG. 7, resulting on a more complex exemplification of the turbine from the construction point of view, but allowing to maximize the ratio working blade area vs returning blade area. As mentioned earlier the combination of the embodiments is considered also covered on the spirit of the present invention and is not being described as a separated embodiment of the invention. This example is presented to show the possibility of curved nested blades, and the multi guidance system, where each fixed guide has a different shape depending on its purpose, working all at the same time. Each blade is composed by a FBP 72 which connects the blade with the spindle axis 23, and act as a frame to allow the MBPs 73 to rotate on its own longitudinal axis, as well as allowing the composed MBP 74 to displace relative to 72 in order to extend or contract the radial length of the blade when required. The MBP 74 in addition to the displacement along 72 also permits the rotation of the smaller MBPs 75 on its own longitudinal axis in such a way that during the working region, the MBP 74 is fully extended and both the MBPs 73 and 75 are in closed position, while during the “return region”, the MBP 74 is contracted or hidden behind the FBP 72 and both the MBPs 73 and 75 are in “open” position, in order to face the minimal area to the flow. The three descripted movements are produced by the displacement of the followers 76, 77 and 78. Follower 76 is in charge of the rotation of the MBPs 73, follower 77 produces the displacement of the MBP 74 along 72 and the relative movement between the follower 77 and 78 produces the rotation of the MBPs 75.

FIG. 17 is a plan view of the same rotor exemplified on the FIG. 16 including the platform 79, the acceleration deflector 80, the blocking deflector 81, the internal fixed guide 82, the middle fixed guide 83, the external fixed guide 84, and the turbine rotor with the four blades 85a, 85b, 85c and 85d. The turbine is placed on a flow as indicated, rotating on the indicated clockwise direction, and at the specific moment represented on the FIG. 17, the blade 85a is located on the thrust point, completely extended and with its MBPs closed, in order to transmit the maximum power to the rotor, while the blade 85c is completely contracted and with its internal MBPs open to face the minimal area to the fluid to produce the minimal resisting torque on the rotor. To produce the relative movement of the MBPs of each blade as the rotor turns, each one of the followers 76, 77 and 78 shown in FIG. 16 is moved by the rotation of the rotor, and as they are restricted to move following the fixed guides, they produce a relative movement between them. For this specific example, all the relative displacements consist in radial displacements respect the spindle axis of the rotor. The follower 76, 77 and 78 in FIG. 16 move along the fixed guides 82, 83, 84 in FIG. 17 respectively. As can be shown, the profile of the curves descripted by the fixed guides 82, 83 and 84 are different from each other, which produces the relative movements, and they are not necessarily symmetrical, as the area variation not necessarily follows a symmetrical profile.

FIG. 18 is a plant view of an example of the third embodiment of the present invention with a four blades rotor rotating on the indicated clockwise direction, where the MBPs of each blade 86a, 86b, 86c, 86d rotate on its own longitudinal axis in order to modify its area facing the flow, by means of the rotation of the followers 87a, 87b, 87c, 87d represented by a rotatory disc, respectively attached to each MBP. The rotation of the followers 87a, 87b, 87c, 87d occurs because of the non-slipping rolling contact between each follower and the fixed guide 88 represented by a fixed disc without any relative movement or rotation respect to the platform 89. One example of the rotatory followers 87a, 87b, 87c, 87d are toothed wheel gearing with the fixed guide 88 also exemplified with a toothed wheel. The fixed guide 88 may be as represented in FIG. 18 as an external teeth gear or like an internal toothed gear or crown. The MBPs 87a, 87b, 87c, 87d are constantly rotating on the same direction on its own axis along the turn of the rotor, being required a specific gearing ratio between the follower disc and the fixed guide disc in order to ensure that the MBPs complete half a turn per every complete turn of the rotor, being this gearing ratio 2:1, meaning in the case of gears, two times the teeth number of the follower gear with respect to the teeth number of the fixed guide gear. For this reason, the diametrically opposed blades on the rotor are rotated 90 degrees from each other, allowing the blade at the thrust point being completely extended facing the biggest area to the flow, while the blade at the drag point is rotated 90 degrees respect to it facing the minimal resistance to the flow. Because every rotation of the turbine rotor the MBP 86a, 86b, 86c, 86d will alternate its side facing the flow, in order to ensure a continuous operation of the device it is required that the MBPs be symmetrical in two planes, and that the self-rotation axis of each MBP be at the intersection of both symmetry planes, parallel to the axis of the turbine rotor. The main advantage of this embodiment is that each MBP is in every position along the rotation of the turbine rotor on its best orientation in order to transmit the maximum torque to the turbine rotor while passing through the working region, and facing the minimal area to the flow while passing through the return region.

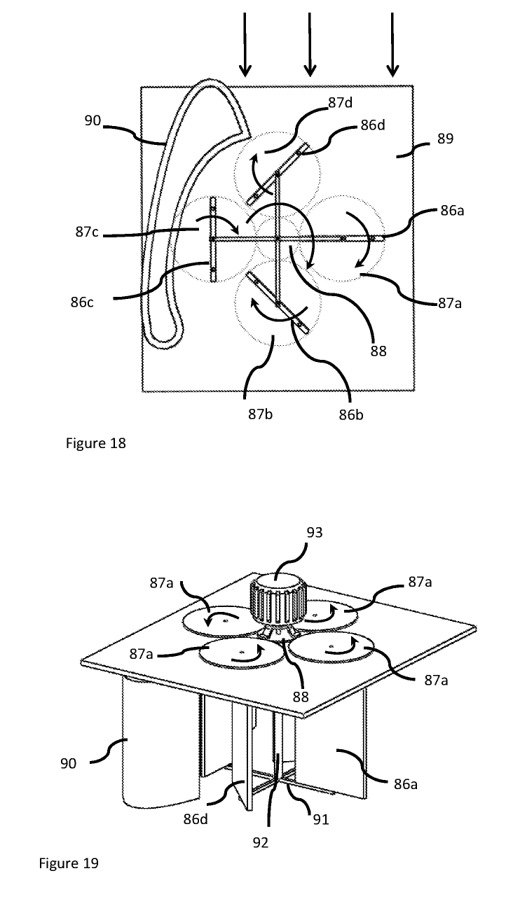

FIG. 19 is a partial perspective view of the same exemplification of the third embodiment of the present invention shown on FIG. 18 with the followers 87a, 87b, 87c, 87d rolling over the fixed guide disc 88, with only one blocking deflector 90 to stop the flow impacting on the returning blades. The MBPs 86a, 86b, 86c and 86d rotate on its own axis which is supported by the FBPs 91 on each blade, which are rigidly attached to the rotor spindle shaft 92, which is attached to the power generation unit 93.

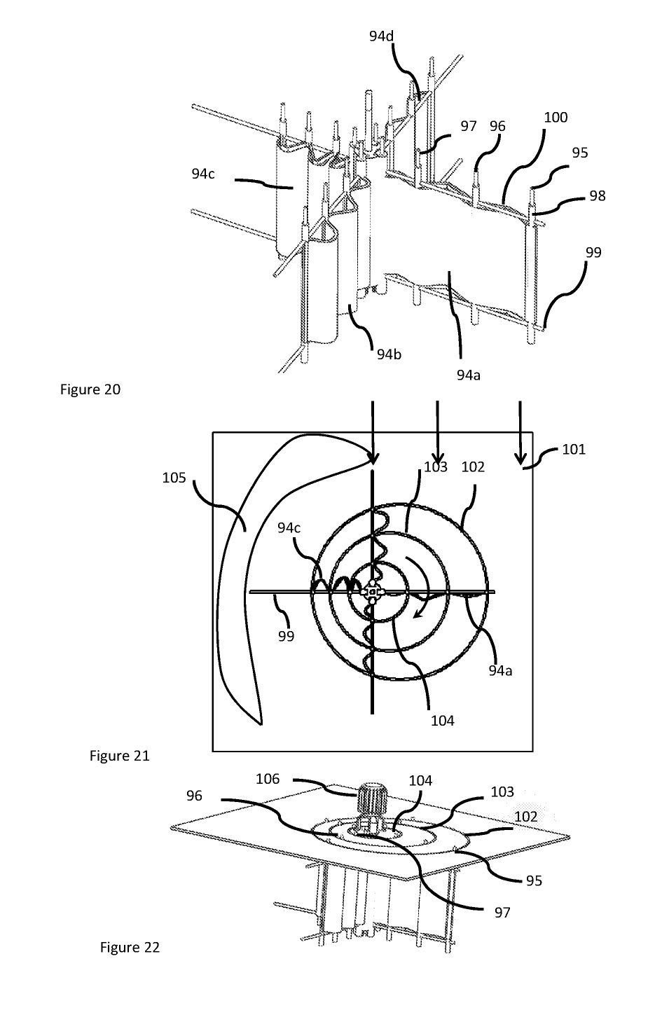

FIG. 20 is a partial perspective view of the rotor of the fourth embodiment of the present invention, composed for this example of four deformable blades 94a, 94b, 94c, 94d, being the blade 94a at the thrust point, totally extended to face the most of its area to the flow, while the blade 94c is contracted to face the lesser resistance to the flow at the drag point. The variation of area on the fourth embodiment of the present invention occurs by means of a controlled deformation, folding or pledging of a part of the blade which will be called also MBP, which may be composed of continuous and flexible material like a plastic, metal or fabrics foil or sheet, or being formed by joining together smaller sheets or plates in order to compose a continuous sheet when extended. The MBP deformation is driven by the movement of the followers that for this exemplification are three per each blade, the outer follower 95, the middle follower 96 and the internal follower 97, that for the spirit of the invention could be from a single follower up to a not determined number of followers, understanding that the lesser the number of followers per blade, the simpler of the mechanics of the system, but also the size of the folds are bigger which is not desirable from the drag force generated to pledge and to move. The followers 95, 96, 97 move a folding element 98 which transmit the movement to the deformable MBP, and either the folding element 98 or the deformable MBP 94a, 94b, 94c, 94d or both move along a guiding elements of the blade 99, which will be the FBP of each blade, in charge of transmitting the force exerted by the fluid on the blade to the rotor. For exemplification purposes FIG. 20 shows two guiding elements of the blade 99 per each blade, but it could be provided a single element or multiple elements, mainly depending on the size of the blade. To ensure the controlled shape of the fold, and to make even that the fold occurs at the desired side of the blade, there are folding liners 100 between the folding elements 98 that force the deformable sheet of the MBP 94 to adopt the “V” shape when folding. These folding liners 100 can be integrated on the deformable sheet of the MBP 94 or can be separated elements joined discretely to the MBP 94 to warranty the shape at folding. To reduce the drag force of the blades when they are on their contracted shape while passing through the return region, it is provided a method that makes the “V” shaped folded sheet opens at the line created at the vertex of the “V”, in order to allow the fluid to pass through it, getting sealed again as the sheet is extended back to transmit the fluid force along the working region. An example of his open-when-folded and closed-when-extended property of the sheet may be a superposed joint between the two sides of the “V”.

FIG. 21 is a partial plant view of the four blade rotor of the fourth embodiment of the present invention as shown in FIG. 20 including the platform 101, and the fixed guides to restrain the movement of the followers, being the outer guide 102, the middle guide 103 and the inner guide 104, for each one of the respective followers 95, 96, 97 from FIG. 20. As the rotor turns, each follower displaces along its corresponding fixed guide, changing the relative distance between each pair of two consecutive followers of the same blade, and this change in distance due to the eccentricity of the fixed guides 102, 103, 104. The geometrical profile of the fixed guides may be any closed curve, preferably mathematically soft, which means each segment of the curve is tangent with its colliding segment and are continuous, being possible to have some portions of such curve as straight lines. As example of the geometrical profile of the fixed guides is shown by circular elements in the fixed guides 102, 103, 104. The blocking deflector 105 in this particular example is far from the contracted MBP blade 94c because of the distance to avoid the FBP 99 makes contact with that deflector.

FIG. 22 is a partial perspective view of the same device shown in FIG. 21 without the blocking deflector, showing the power generation unit 106 on the platform 105 with the fixed guides 102, 103, 104 on it to restrain the followers 95, 96, 97 of each blade to move along them.

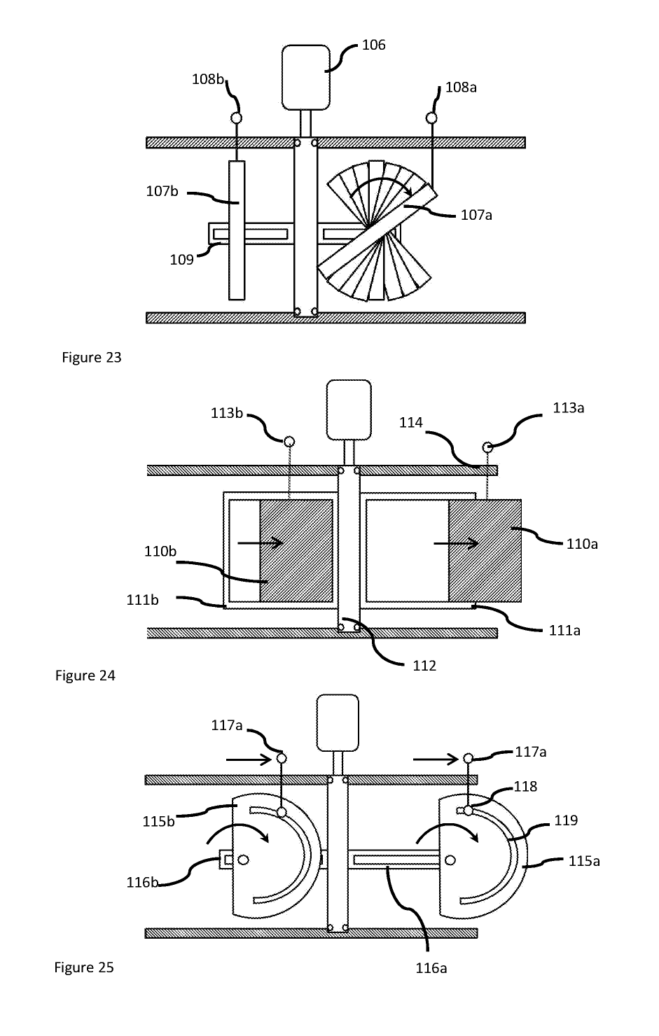

FIG. 23 is a cross sectional view of a turbine of the fourth embodiment of the present invention where the area variation of the diametrically opposed blades 107a and 107b by pledging or folding segments of a deformable sheet occurs for rotation of the flexible MBP, because of the movement of the follower 108a and 108b attached to them. As the turbine rotor rotates, each follower 108a and 108b moves along its corresponding fixed guide variating the radial distance to the rotor axis, while a pivot of the MBP is attached to the FBP 109, holding the MBP to transmit the forces to the rotor, but at the same time allowing it to rotate in perpendicular direction. An example of this MBP is shown in FIG. 23 similar to a hand-held traditional fan, which has the segments forming the MBP spread as the 107a, corresponding to a working blade, or contracted occupying the minimal area as the blade 107b, corresponding to a returning blade.

FIG. 24 is a cross sectional view of the fifth embodiment of the present invention showing a turbine with two diametrically opposed blades with capability of varying their radial position respect to the rotor axis. The torque produced by the flow on the rotor is a product of the force of the flow on the blade times the distance of this force to the rotor axis. The previous four embodiments of the present invention consisted on modifying the area of the blade, but the fifth embodiment consists in displacing the area of the blade closer or farther to the rotor axis (i.e., increasing the radial distance) in order to increase the working torque on the working blades by placing its area away from the rotor and diminishing the drag torque on the returning blades by moving its area closer to the rotor axis. As stated previously, the blade is composed by MBP and FBP elements. The MBP in this embodiment correspond to the hatched elements 110a and 110b, which are the elements which face the most of the area of the blade to the flow, and are displaced in order to increase or decrease the torque on the rotor. The FBPs are the elements 111a and 111b which are reduced area elements like empty frames attached to the rotor shaft allowing the MBP 110a and 110b to displace on them while holding them to transmit the force exerted by the fluid on it to the rotor shaft 112. MBP 110a is located at its farthest position respect to the rotor shaft 112 corresponding to a working blade producing the maximum working torque, while the MBP 110b is located at its closest position respect to the rotor shaft 112, corresponding to a returning blade transmitting the minimal drag torque to the rotor. The change in position of the shown MBPs 110a and 110b consists on a lineal movement driven by the movement of the followers 113a and 113b respectively, which are attached to each of them, which are restrained to move along a fixed guide 114 as the rotor rotates in the same manner that the preceding embodiments. An example of the geometrical profile of the guide is the element 36 on FIG. 9.

FIG. 25 is a cross sectional view of the fifth embodiment of the present invention showing a turbine with two diametrically opposed blades with capability of varying their radial position respect to the rotor axis by means of a rotational movement of the MBP over the FBP. The MBP 115a is located at its farthest position from the rotor axis corresponding to a working blade producing the highest working torque possible on the rotor shaft, while the MBP 115b is located at its closest possible position respect to the rotor ais, producing the minimal drag torque possible on the rotor shaft. The shown MBP 115a and 115b are capable of rotating around a pivot point located on the FBP 116a and 116b respectively, producing a relative rotation respect to such FBP. The rotation of the MBPs respect to the FBPs is driven by the movement of the follower element 117a and 117b along a fixed guide element which restrain its movement as the followers move by the rotation of the rotor. An example of the mechanism to drive the rotation of the MBPs from the movement of the followers is shown in FIG. 25 by followers 117a and 117b which are restrained to move horizontally by the fixed guide, changing their relative position respect to the rotor axis as the rotor turns, transforming the linear radial displacement of the follower into rotation by means of the displacement of a secondary follower 118 along a MBP guide 119 on each blade, being possible the use of any other known mechanism to produce the rotation of the MBP element relative to the FBP from the movement of the follower.

The five preceding embodiments of the present invention has been described indistinctly with the presence or absence of the deflector elements, being possible to have on the devices a blocking deflector which blocks the flow entering the turbine in order of reducing its speed of the flow on the returning area to diminish the drag torque of the returning blades, an acceleration deflector which increases the speed of the flow entering the turbine through the working area in order to increase the working torque produced by the working blades, being possible having turbines with one of the two deflectors installed, both at the same time or none of them, being the deflectors disclosed so far static elements with the main functionality of conditioning the flow because of their geometry and surface as it enters, passes thru and exits the device.

There are three methods of flow conditioning deflectors in the present invention, all of them with the same objectives based on two static equal deflectors with an airfoil type cross section each, consisting of at least a nose, two sides and a tail. The nose is oriented at an attack angle respect to the flow current in such a manner that when the two deflectors are located in parallel create an inlet nozzle to accelerate the flow coming into the turbine. The two sides of each deflector are different in such a manner that the side colliding with the “return region” of the rotor is concave and it is called the “return side”, and the side colliding with the “working region” of the turbine is mainly convex and is called the “acceleration side”. The flow acceleration is made by means of the geometrical convergent shape of the nose of the “blocking deflector” and the acceleration side of the “acceleration deflector”, which progressively reduces the passing section of the flow as it approaches to the axis of the rotor creating a funnel effect, and because of a low friction surface, which reduces the energy losses. The “return side” of the “blocking deflector” despite of its concave geometry which facilitates the pressure release of the recirculating flow tending to move counter current (upstream direction) pushed by the blades passing through the “return region”, also have a directional flow friction treatment on its surface, which behaves as a low friction surface when the flow moves upstream, and as a high friction surface when it moves in downstream direction. This property is achieved by means of geometrical protrusions on the walls or by a shark's skin cover, both methods minimizing the friction in one direction and increasing it on the other.

The sixth embodiment of the present invention corresponds to a variable blade area turbine with a static kind of blocking deflector which produces a pressure drop on the return region of the turbine by applying Venturi effect to create a pressure difference between the flow at both sides of the deflector, accelerating the flow in the acceleration side of the deflector to produce a suctioning force that decreases the pressure on the fluid located on the return side of the deflector, which corresponds to the return region of the turbine. The advantage of this deflector is that the low pressure on the fluid located in the return region of the turbine opposed less resistance to the movement of the blades through it, reducing the drag torque produced by the returning blades, which means an increment in the net output torque of the turbine.

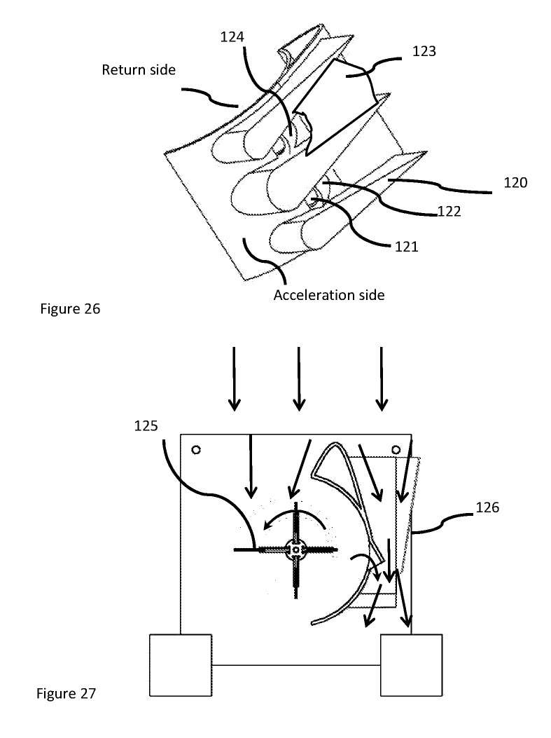

FIG. 26 is a detail perspective view of the static deflector of the sixth embodiment of the present invention using the Venturi principle, with acceleration ribs 120 which form a convergent or funnel-like geometry in order to accelerate the flow on the acceleration side of the deflector, being those ribs 120 being covered by the funnel cover 123, partially removed on FIG. 26 for visualization purposes, which contributes to create the funnel convergent geometry called acceleration channel 124. The speeded up flow passes over the communication conduct 121 which has a conduct cover 122 to avoid it enters through it from the acceleration side to the return side of the deflector. The communication conduct 121 put in contact the flow at both sides of the deflector, making the fluid in the return side of the deflector to be suctioned towards the acceleration side side of the deflector because of the pressure drop created by the accelerated flow in the acceleration side. There is not a specific number of acceleration ribs 120 nor communication conducts 121 per acceleration channel 124, but an example is the deflector in FIG. 26 which has three acceleration ribs 120 and one communication conduct 121 per every acceleration channel 124.

FIG. 27 is a plant view of the sixth embodiment of the present invention, showing a four variable area blade rotor 125 with the elements previously described on the embodiments one to five, with a blocking deflector 126 using the Venturi effect described for FIG. 26. The flow lines represented by the arrows show how the fluid passing through the acceleration channel of the deflector 126 is accelerated, being the maximum speed point the region where the communication conduct is located, showing the lines of flow of the fluid passing from the return side of the deflector, corresponding to the return region of the turbine rotor, towards the acceleration side of the deflector, where the outer flow is being accelerated.

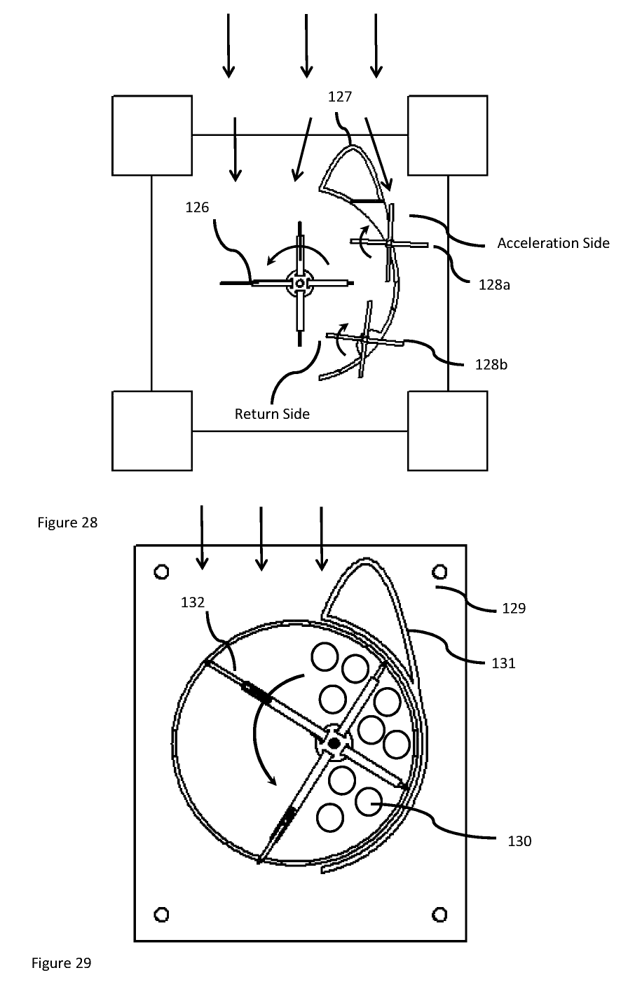

FIG. 28 is a plan view of the seventh embodiment of the present invention, consisting on a four variable area blade rotor 126 of any kind as explained on embodiments one to five, with a dynamic “blocking deflector” 127, consisting on the basic components described for the static blocking deflectors previously disclosed like nose, tail, return side and acceleration side, but including one or more secondary rotating blade rotors (called SRBR) 128 whose rotation axes are parallel to the axes of the variable blade area turbine rotor, with the blades of each SRBR 128 protruding out from both deflector 127 sides in such a manner that when the blades passes through the “acceleration side” of the deflector they are impelled by the flow, driving the rotation of its rotor, which makes the blades passing through the “return side” of the deflector impel the fluid in that region. The rotation of the SRBR 128a and 128b occurs in counter direction to the turbine rotor, in order to make the fluid in the “return region” to circulate in the same direction of the turbine rotor rotation, in the example shown in FIG. 28 the variable area blade turbine rotor 126 is moving counterclockwise while the SRBR 128a and 128b move in clockwise direction. The best use of the SRBRs 128a and 128b is to rotate synchronically with the turbine rotor 126, allowing the blades of the SRBR 128a and 128b to “gear” not necessarily with physical contact but staggered in the inter-blade space of the turbine blades of 126, meaning one turn of the SRBR 128a and 128b every single turn of the rotor 126, but it is not limited to rotate without any synchronicity. The SRBR 128a and 128b can be mechanically connected through any mechanical transmission components to each other or to the turbine rotor 126 or being independent meaning without any interconnection. In the example shown in FIG. 28 there is no mechanical transmission for interconnection. There is not a limit number of SRBR for each deflector, being possible to have equal size or different size SRBR on the same deflector. It is possible to mechanically engage several SRBR to each other in order to use some of them as driving turbine for the others, which would allow some of the SRBR blades to protrude only from the “return side” of the deflector.

The SRBR 128a and 128b of the seventh embodiment can be used as a secondary driver for power generation units independent or interconnected to the primary power generation unit, which is driven by the variable blade area turbine 126.

The blades of the SRBRs 128a and 128b can be fixed area blades or can be variable area blades by using any of the principles disclosed on embodiments one to five of the present invention.

FIG. 29 is a plan view of the present invention with a modified platform 129 with perforations 130 distributed along the return region, in order to allow the evacuation of fluid from the inner side of the turbine, meaning the volume limited by the upper and lower platforms 129, the blocking deflector 131 and the variable blade area rotor 132 itself, outwards the outside of the turbine, because of the difference in pressure between higher pressure inner side of the turbine and the lower pressure−higher speed flow outside of the turbine. To avoid the entrance of the outer fluid through the perforations 130, while allowing the fluid inside the turbine to get out, it is provided a unidirectional mechanism of flow.

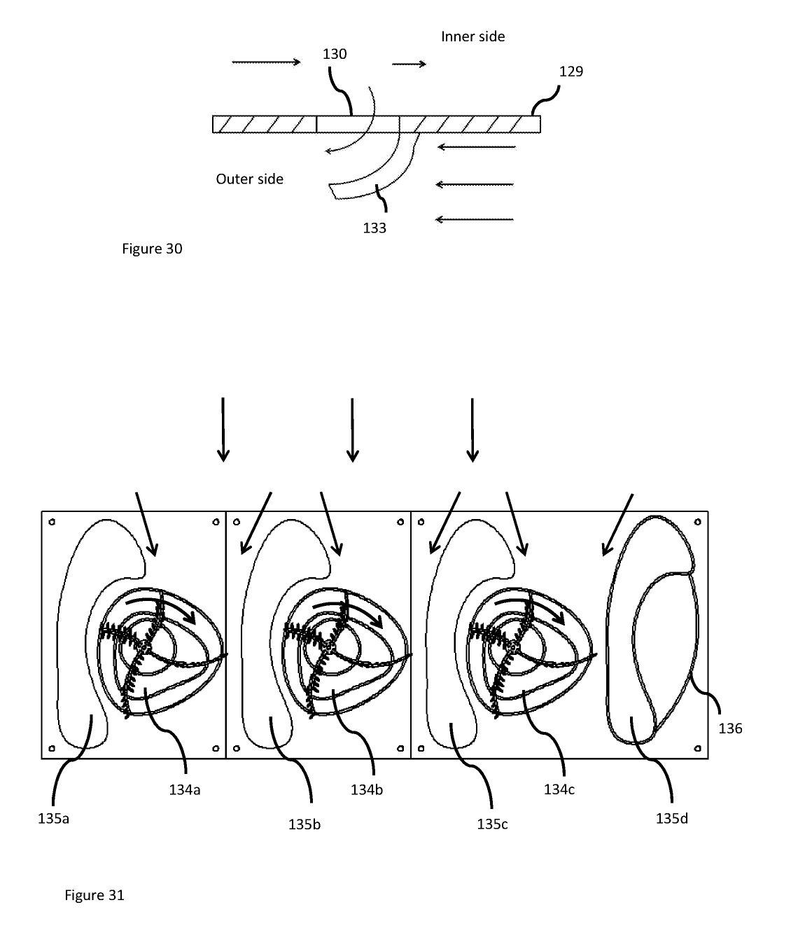

FIG. 30 is a detailed cross sectional view of one of the platforms 130 with the perforation 130 and an example of the unidirectional mechanism of flow 133, represented in FIG. 30 by a cover with a downstream opening in such a manner that the outer fluid flowing in the indicated direction doesn't get into the perforation, and the fluid inside the turbine can flow through perforation 130 because of the difference in pressure between both sides. The Venturi effect used for the blocking deflector of the sixth embodiment of the present invention could be also used.

In order to increase the generated power of the system to cover the demand, the present invention can be implemented as 1) a single rotor variable blade area turbine alone scaled to a size that provides the complete amount of power required, 2) a group of separated single rotor variable blade area turbines or 3) combined in an array of parallel single rotor variable blade area turbines placed side by side. The first option may result in a difficult to build, difficult to transport and difficult to install device, being even possible to not operate appropriately because of the high inertia to move the components, especially when thinking that the present invention main destiny are low speed flow currents. The main advantage of using parallel arrays of turbines instead of separated units alone is that the overall efficiency of the system can be superior to the sum of the efficiency of the single rotor turbines, because of the benefits of the flow conditioning as a result for sharing the deflectors between the consecutive turbines. As the turbine array behaves as a partial dam or barrier in the stream, the fluid is forced to flow through the turbines inlet which represent an area reduction resulting in flow acceleration, meaning more energy transmitted to the rotors. In the case of physically separated single turbines, it is easier for the flow to skip the barrier, making only part of the fluid to go through the turbine, because the fluid will tend to flow through the minor resistance path, in this case, being the outside of the turbine. Another advantage of the parallel array of turbines is the use of less deflectors, because it is used a single deflector between two consecutive rotors, instead of the two deflectors used in separated turbines. The use of a single anchoring for multiple turbines is also an advantage of using an array of parallel turbines placed side by side.

FIG. 31 is a plan view of an array of three parallel variable blade area turbines as disclosed in embodiments one to five of the present invention, with the rotors 134a, 134b, 134c located side by side rotating in clockwise direction, separated by the deflectors 135a, 135b, 135c, 135d. The number of turbines in the array may be from two up to a not determined number, limited by the physical space to allocate them on the stream and the practical considerations like obstruction to transit. It can be seen from FIG. 31 the area reduction at the turbine inlet, resulting in higher energy transmitted to the rotor, being the area reduction proportional to the effective radius of the rotor, calculated as the sum of the total length of the blade at the thrust point plus the total length of the blade at the drag point divided by two, and the width of the deflector nose, measured close to the rotor and in perpendicular direction to the flow. This indicates that a method to maximize the flow passage area reduction of an array of turbines, increasing the output power of the system, it is simply by increasing the width of the deflector nose, this can be achieved by having any kind of deflectors capable of variating its shape or having different sets of fixed replaceable deflectors each of different width. An example of deformable deflectors for this purpose could be a “V shaped” hinge-like nose deflector made of two sides articulated which can open to increase the deflector nose width or close to decrease the nose width. FIG. 31 shows an example of fixed width replaceable deflectors 135a, 135b, 135c, 135d of the kinds stated on the embodiments already disclosed on the present invention, which have two sides, being the left side as shown in FIG. 31 the accelerating side and the right side the return side. From the maintenance and manufacturing point of view the preferred option for an array of turbines like the example in FIG. 31 is to have equally sized rotors and deflectors, giving a modularity capability to the system, however the turbine arrangements disclosed on the present invention are not limited to equally sized components or even equal type of variable area blade rotors or deflectors, considering all of these possibilities included on the spirit of the invention.

In order to balance the force of the flow over the turbine structure including deflectors, platforms, and rotors and to minimize the forces in perpendicular direction to the flow mainly because of the asymmetry of the system, it is applied the deflector flap 136 shown in FIG. 31 which compliments the shape of the deflector 135d. The fluid exerts on the deflector flap 136 a lateral force that compensates the lateral force produced by the asymmetry of the system. To achieve this, the deflector flap 136 may be movable to better adapt to the specific conditions of the flow and geometry of a turbine arrangement, or can be fixed. The example shown in FIG. 31 represents a fixed flap deflector.

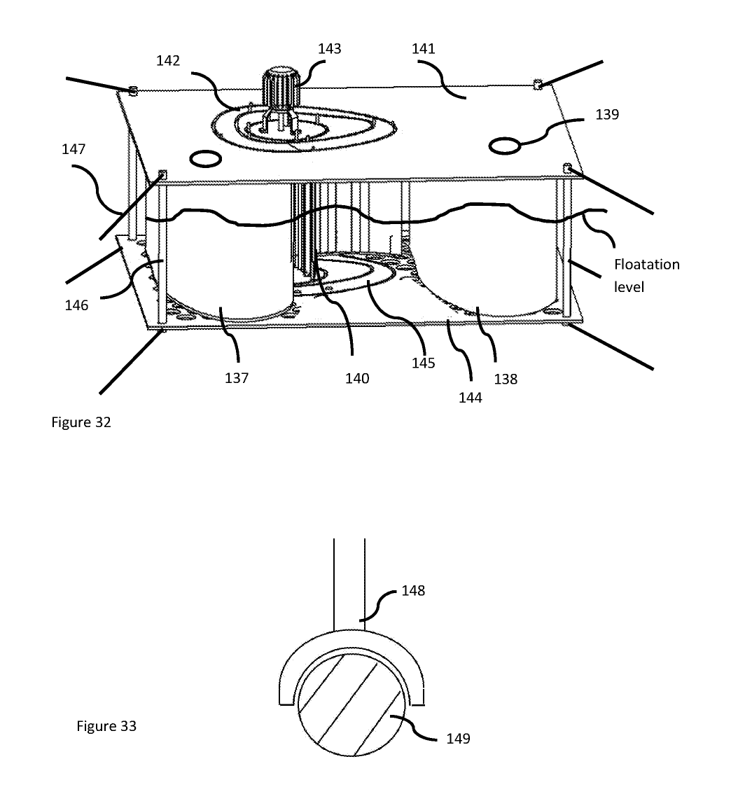

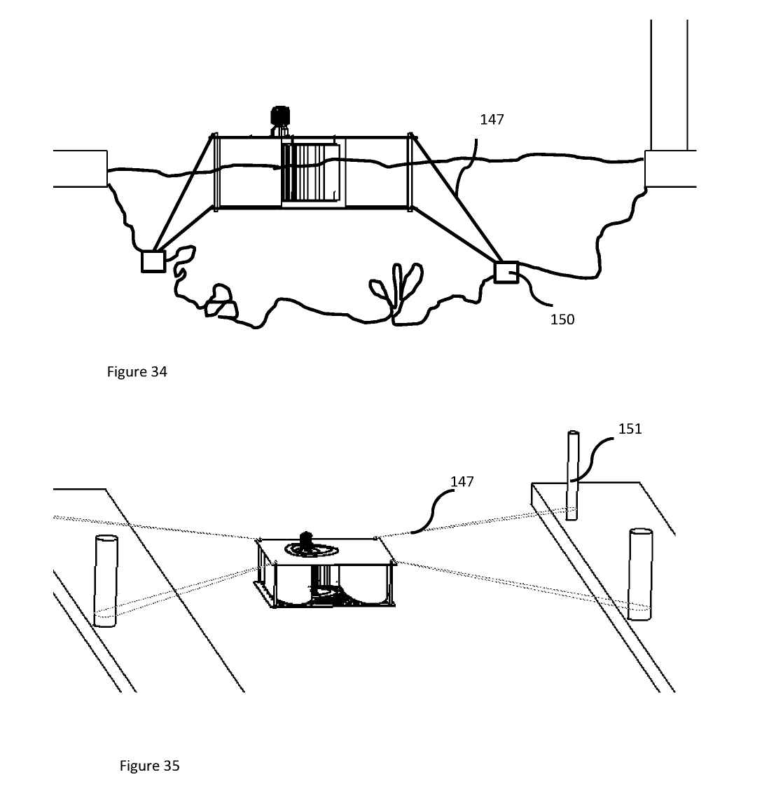

FIG. 32 is a perspective view of a particular application of the present invention when working as a floating turbine located on water channels or rivers, with the acceleration deflector 138 and the blocking deflector 137 working as the floating elements of the turbine. The deflectors 137 and 138 are a hollow body sealed to avoid the entrance of water on the submerged portion of them, and with an opening 139 on each of them in the side located out of the water, in such a manner that it can be regulated the floating level of the device by adding or removing water from the interior of the deflector thru this openings 139. An example of the deflector 137 and 138 could be a thin wall body generated by roto-molding in a polymer like polyethylene, in the same way that are manufactured certain Kayak boats. The deflectors are also the protective element for the rotor 140 against the impact of objects and debris being dragged by the water. Additionally, the deflectors 137 and 138 have structural functionality in order to maintain the stiffness of the device. At the top side of the deflectors 137 and 138 it is located the top platform 141 which is intended to be out of the water, but not limited to be underwater, which function is to allocate the top fixed guide 142, the bearings for the rotor shaft, the mechanical transmission and the power generation unit 143, being this the main reason to stay out of the water. The variable area blade rotor 140 in the example of FIG. 32 belongs to any of the types shown on embodiments one to five of the present invention, having a vertical rotation axis and intended to operate totally submerged or partially submerged. In FIG. 32 the floating line indicates that the rotor is semi-submerged. The level of immersion of the rotor 140 depends on the water level inside the cavity of the deflectors 137 and 138. A method to regulate the output power of the turbine is to control the floatation level of the device, as the output power of the turbine is proportional to the portion of the rotor length under water. Additionally, the control of the turbine floating level represents an advantage of this device to better adapt to a changing flow conditions on rivers and water channels, especially because of seasonal changes because of rainy or dry seasons. This method allows having a large rotor turbine operating on a deep river at a high power output capacity along part of the year and when the river level decreases, the turbine can still operate with a lower power output by simply variating the floatation level of the turbine. At the bottom of the deflectors 137 and 138 it is the submerged platform 144, which besides of its structural function allocates the other bearings of the rotor, and as in the example shown in FIG. 32, can allocate the submerged fixed guides 145. The submerged fixed guides and their corresponding followers are any kind of mechanical guiding component as the ones mentioned earlier for the fixed guides, but at difference of them require to be much simpler and reliable if considering that the underwater condition will impact on lubrication matters and stocks and jams with debris. An example of submerged fixed guide and follower is shown in FIG. 33. To ensure cohesion of the device additionally to the deflectors 137 and 138 are provided joining elements 146 to keep the platforms and deflectors together. The ties 147 are provided for the anchoring of the device, preferably located at the corners of the platforms as shown in FIG. 32. Some examples of the tie element 147 are metal cable, ropes, metal chains, synthetic wires or any similar element with enough mechanical traction resistance to hold the device in position, as well as corrosion resistant.

FIG. 33 is a detailed cross sectional view of an example of the submerged fixed guide with its corresponding follower as explained for the application FIG. 32. Element 148 is the follower attached to the MBP of the turbine rotor, and it slips over the bottom fixed guide element 149 having simple contact. The lubrication between them is provided by the surrounding water, and as an example it could be used low friction, high waring and corrosion resistant materials for the follower 148 and a stiff, smooth surface, corrosion resistant material like stainless steel for the guide 149.

There are three different methods for holding and positioning the device exemplified in FIG. 32.

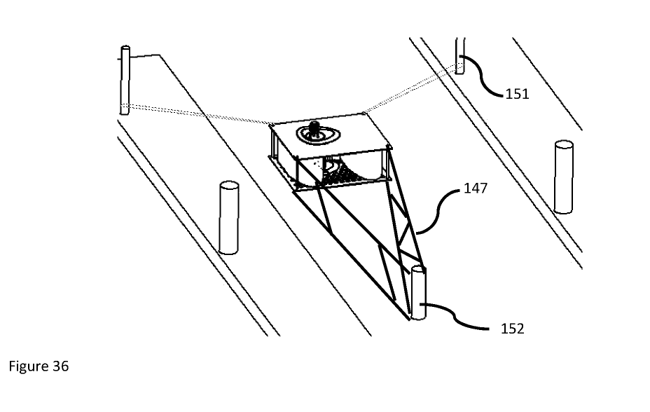

FIG. 34 is a front view of the floating water turbine described on FIG. 32 with an anchoring system to the river bed. The ties 147 are linked to submerged elements 150 anchored in the river bed, being either elements located on the river or pillars specially placed for this purpose. The anchoring must warranty that the turbine keeps its direction respect to the stream.

FIG. 35 is a perspective view of the floating water turbine described on FIG. 32 with an anchoring system attached to elements on the riversides. The ties 147 are attached to the elements 151 which may be elements located in the riverside like trees, rocks, or any existing or especially built construction or pillar to link the ties 147.

FIG. 36 is a perspective view of the floating water turbine described on FIG. 32 with an anchoring system attached to elements on the riverbed and riversides combined. The main advantage of this anchoring system is besides the anchoring function, the possibility of having a single pillar 152 or anchoring point upstream to use the ties 147 attached to it to thread a net-like element with them to use it as a protection for the turbine to deviate any trunk or voluminous debris from the turbine inlet.

While the preferred embodiment and various alternative embodiments of the invention have been disclosed and described in detail herein, it may be apparent to those skilled in the art that various changes in form and detail may be made therein without departing from the spirit and scope thereof.

We claim:

1. A power generation apparatus for generating power from water flows, the power generation apparatus, comprising:
a generator,
a series of blades at least partly submerged in the water flow and being movable by the water flow;
at least one follower attached at least one of the blades wherein the follower is configured to move cooperatively with at least one of the blades;
being the follower adapted to perform a deformation action on at least one of the blades wherein the deformation action on the blades is determined by the position of the follower along a deformation path.

2. The power generation apparatus according to claim 1, wherein the apparatus further comprises a guide that defines the deformation path being the follower configured to move along the guide.

3. The power generation apparatus according to claim 1, wherein each of the series of blades is attached to the follower.

4. The power generation apparatus according to claim 1, wherein the follower is adapted to perform a deformation action on each of the blades of the series of blades.

5. The power generation apparatus according to claim 1 wherein the apparatus comprises one follower attached to each blade.

6. The power generation apparatus according to claim 1, wherein the blades perform a rotational movement around a rotation axis and wherein the deformation path comprises at least two different radial distances from the rotation axis.

7. The power generation apparatus according to claim 6, wherein the deformation path is an elliptical path.

8. The power generation apparatus according to claim 6, wherein the deformation path is a circular path eccentric with respect to the rotation axis.

9. The power generation apparatus according to claim 1, wherein the blades perform a rotational movement around a rotation axis and wherein the deformation path comprises at least two different axial distances from the rotation axis.

10. The power generation apparatus according to claim 9, wherein the deformation path is a substantially stepped path.

11. The power generation apparatus according to claim 1, wherein the deformation action modifies the effective area of the blades.

12. The power generation apparatus according to claim 1, wherein the deformation action is defined by a working area and a return area wherein in the working area the effective area of the blade is higher than on the return area.

13. The power generation apparatus according to claim 1, wherein the deformation action comprises a displacement, rotation and/or deformation action of at least part of the blades.

14. The power generation apparatus according to claim 1 wherein the deformation action comprises extending the length of the blade

15. The power generation apparatus according to claim 14, wherein the blade comprises a telescopic portion wherein the length of the blade is modified by means of the deformation action.

16. The power generation apparatus according to claim 14, wherein the blade comprises a foldable portion wherein the folding of the blade is controlled by means of the deformation action.

17. The power generation apparatus according to claim 1, wherein the blade comprises a set of windows wherein the deformation action modifies the aperture of the windows.

18. The power generation apparatus according to claim 1, wherein the deformation action comprises a rotation of the blade over its own axis.

19. The power generation apparatus according to claim 18, wherein at least one of the blades has an airfoil shape or a curved shape.

20. The power generation apparatus according to claim 19, wherein the deformation action modifies the attack angle of at least one of the blades.

21. The power generation apparatus according to claim 1, wherein the deformation action comprises a linear displacement of the blade along its an axial direction.

22. The power generation apparatus according to claim 1 further comprising a deflector being such deflector configured to at least partially block the water flow that is directed towards a region of the apparatus.

23. The power generation apparatus according to claim 22, wherein the apparatus comprises a working area and a return area, being the working area the region wherein the blades move in the same direction was the water flow and the return area the area wherein the blades move in the opposite direction and wherein the deflector is configured to block the water flow that is directed towards the return area.

24. The power generation apparatus according to claim 23, wherein the deflector comprises a set of secondary rotating blades.

25. The power generation apparatus according to claim 24, wherein the secondary rotating blades comprise an axis parallel to the axis of the blades.

26. The power generation apparatus according to claim 25, wherein the secondary rotating blades are configured to rotate in a direction opposite to the rotation direction of the blades.

27. The power generation apparatus according to claim 24, wherein the secondary rotating blades are variable area blades.

28. The power generation apparatus according to claim 23, wherein the deflector comprises a set of ribs covered by a funnel cover such ribs and such funnel cover defining an acceleration channel.

29. The power generation apparatus according to claim 28, wherein the acceleration channel comprises a mechanism to prevent fluid from entering the return area via the acceleration channel.

30. The power generation apparatus according to claim 29, wherein the mechanism is a check valve.

31. The power generation apparatus according to claim 29, wherein the mechanism is a set of self orientating lids.
